(19) United States
(12) Patent Application Publication
(10) Pub. No.: US 2022/0022279 A1
(43) Pub. Date: Jan. 20, 2022

(54) LOW POWER OPERATION METHOD OF TERMINAL SUPPORTING DIRECT COMMUNICATION, AND APPARATUS FOR THE SAME

(71) Applicant: ELECTRONICS AND TELECOMMUNICATIONS RESEARCH INSTITUTE, Daejeon (KR)

(72) Inventor: Jae Heung KIM, Daejeon (KR)

(21) Appl. No.: 17/367,998

(22) Filed: Jul. 6, 2021

(30) Foreign Application Priority Data
Jul. 15, 2020 (KR) 10-2020-0087687
Jul. 21, 2020 (KR) 10-2020-0090517
Nov. 13, 2020 (KR) 10-2020-0152057
Jun. 30, 2021 (KR) 10-2021-0085532

(51) Int. Cl. H04W 76/28; H04W 72/14; H04W 8/24

(52) U.S. Cl. CPC H04W 76/28; H04W 92/18; H04W 8/24; H04W 72/14

(57) ABSTRACT

An operation method of a sidelink (SL) receiving terminal for low power consumption may include: transmitting sidelink-discontinuous reception (SL-DRX) assistance information for configuring DRX for SL communication to a SL transmitting terminal; and receiving configuration information of DRX parameters for the SL communication configured based on the SL-DRX assistance information from the SL transmitting terminal, wherein the DRX parameters for the SL communication are determined by the SL transmitting terminal or a base station to which the SL transmitting terminal is connected based on the SL-DRX assistance information.

### CROSS-REFERENCE TO RELATED APPLICATIONS

This application claims priority to Korean Patent Applications No. 10-2020-0087687 filed on Jul. 15, 2020, No. 10-2020-0090517 filed on Jul. 21, 2020, No. 10-2020-0152057 filed on Nov. 13, 2020, and No. 10-2021-0085532 filed on Jun. 30, 2021 with the Korean Intellectual Property Office (KIPO), the entire contents of which are hereby incorporated by reference.

### BACKGROUND

### 1. Technical Field

The present disclosure relates generally to a method and an apparatus for low power consumption operations, and more specifically, to a method for efficient radio resource management and discontinuous reception (DRX)-based low power consumption operations of a terminal supporting direct communication between terminals (i.e., sidelink), and an apparatus for the same.

### 2. Description of Related Art

In order to cope with the explosion of wireless data, a mobile communication system considers a terminal apparatus supporting a 6 GHz to 90 GHz band as a transmission frequency for a wide system bandwidth. Further, a method for establishing a direct radio link between terminals to provide services is being considered in addition to a method for establishing a radio link connection with a base station (or cell), a node to which functional split is applied, or a relay node to provide services. As described above, a signaling and control procedure of a radio protocol for low power consumption operations of a terminal supporting a direct communication function between terminals for connected car services as well as a mobile communication system-based general user terminal is required.

### SUMMARY

Accordingly, exemplary embodiments of the present disclosure are directed to providing an operation method of a sidelink receiving terminal for low power consumption.

Accordingly, exemplary embodiments of the present disclosure are directed to providing an operation method of a sidelink transmitting terminal for low power consumption of a sidelink receiving terminal.

Accordingly, exemplary embodiments of the present disclosure are directed to providing an operation method of a base station for low power consumption of a sidelink receiving terminal.

According to an exemplary embodiment of the present disclosure, an operation method of a sidelink (SL) receiving terminal for low power consumption may comprise: transmitting sidelink-discontinuous reception (SL-DRX) assistance information for configuring DRX for SL communication to a SL transmitting terminal; and receiving configuration information of DRX parameters for the SL communication configured based on the SL-DRX assistance information from the SL transmitting terminal, wherein the DRX parameters for the SL communication are determined by the SL transmitting terminal or a base station to which the SL transmitting terminal is connected based on the SL-DRX assistance information.

The SL communication may be SL communication for a unicast service, and the SL communication may be based on a mode 1 resource allocation scheme.

The SL-DRX assistance information may be transmitted through a message for establishing a PC5-radio resource control (RRC) connection between the SL receiving terminal and the SL transmitting terminal or a PC5-RRC control message after the PC5-RRC connection is established.

The SL-DRX assistance information may include at least one of a source identifier and/or a destination identifier, Uu DRX parameter(s) configured in the SL receiving terminal, and SL-DRX parameter(s) configured in the SL receiving terminal.

The SL-DRX assistance information may further include at least one among capability information of the SL receiving terminal, configured grant (CG) configuration information, a SL service being provided to or provided by the SL receiving terminal, bearer configuration information, a cast type of the SL service being provided to or provided by the SL receiving terminal, and DRX parameter(s) for the SL communication preferred by the SL receiving terminal.

When the DRX parameters for the SL communication are determined by the base station, the SL transmitting terminal may transfer the SL-DRX assistance information to the base station, and the base station may determine the DRX parameters for the SL communication based on the SL-DRX assistance information transferred from the SL transmitting terminal.

The SL-DRX assistance information may be transmitted as being included in an RRC connection (re)configuration message, an RRC connection release message, a capability information transfer message of the SL transmitting terminal, a sidelink service request message, and/or a UE assistance information message between the SL transmitting terminal and the base station.

The operation method may further comprise reporting the DRX parameters for the SL communication to a base station to which the SL receiving terminal is connected.

According to another exemplary embodiment of the present disclosure, an operation method of a sidelink (SL) transmitting terminal for supporting low power consumption operations of a SL receiving terminal may comprise: receiving sidelink-discontinuous reception (SL-DRX) assistance information for configuring DRX for SL communication from the SL receiving terminal; and transmitting configuration information of DRX parameters for the SL communication configured based on the SL-DRX assistance information to the SL receiving terminal, wherein the DRX parameters for the SL communication are determined by the SL transmitting terminal or a base station to which the SL transmitting terminal is connected based on the SL-DRX assistance information.

The SL communication may be SL communication for a unicast service, and the SL communication may be based on a mode 1 resource allocation scheme.

The SL-DRX assistance information may be transmitted through a message for establishing a PC5-radio resource control (RRC) connection between the SL receiving terminal and the SL transmitting terminal or a PC5-RRC control message after the PC5-RRC connection is established.

The SL-DRX assistance information may include at least one of a source identifier and/or a destination identifier, Uu DRX parameter(s) configured in the SL receiving terminal, and SL-DRX parameter(s) configured in the SL receiving terminal. The SL-DRX assistance information may further include at least one among capability information of the SL receiving terminal, configured grant (CG) configuration information, a SL service being provided to or provided by the SL receiving terminal, bearer configuration information, a cast type of the SL service being provided to or provided by the SL receiving terminal, and DRX parameter(s) for the SL communication preferred by the SL receiving terminal.

When the DRX parameters for the SL communication are determined by the base station, the SL transmitting terminal may transfer the SL-DRX assistance information to the base station, and the base station may determine the DRX parameters for the SL communication based on the SL-DRX assistance information transferred from the SL transmitting terminal.

The SL-DRX assistance information may be transmitted as being included in an RRC connection (re)configuration message, an RRC connection release message, a capability information transfer message of the SL transmitting terminal, a sidelink service request message, and/or a UE assistance information message between the SL transmitting terminal and the base station.

According to yet another exemplary embodiment of the present disclosure, an operation method of a base station for supporting low power consumption operations of a sidelink (SL) receiving terminal may comprise: receiving sidelink-discontinuous reception (SL-DRX) assistance information for configuring DRX for SL communication from the SL receiving terminal through a SL transmitting terminal for the SL receiving terminal; and transmitting configuration information of DRX parameters for the SL communication configured based on the SL-DRX assistance information to the SL receiving terminal through the SL transmitting terminal, wherein the DRX parameters for the SL communication are determined by the base station based on the SL-DRX assistance information.

The SL communication may be SL communication for a unicast service, and the SL communication may be based on a mode 1 resource allocation scheme.

The SL-DRX assistance information may include at least one of a source identifier and/or a destination identifier, Uu DRX parameter(s) configured in the SL receiving terminal, and SL-DRX parameter(s) configured in the SL receiving terminal.

The SL-DRX assistance information may further include at least one among capability information of the SL receiving terminal, configured grant (CG) configuration information, a SL service being provided to or provided by the SL receiving terminal, bearer configuration information, a cast type of the SL service being provided to or provided by the SL receiving terminal, and DRX parameter(s) for the SL communication preferred by the SL receiving terminal.

The SL-DRX assistance information may be received as being included in an RRC connection (re)configuration message, an RRC connection release message, a capability information transfer message of the SL transmitting terminal, a sidelink service request message, and/or a UE assistance information message between the SL transmitting terminal and the base station.

According to exemplary embodiments of the present disclosure, power consumption of terminals may be reduced while performing a direct communication function between the terminals mounted on moving objects (e.g., unmanned aerial vehicle, train, autonomous vehicle, etc.) as well as user terminals in a mobile communication system.

### BRIEF DESCRIPTION OF DRAWINGS

Exemplary embodiments of the present disclosure will become more apparent by describing in detail embodiments of the present disclosure with reference to the accompanying drawings, in which:

FIG. 1 is a conceptual diagram illustrating a first exemplary embodiment of a wireless communication network;

FIG. 2 is a block diagram illustrating a first exemplary embodiment of a communication node constituting a wireless communication network;

FIG. 3 is a state transition diagram for describing an example of state management for a terminal applied to exemplary embodiments of the present disclosure;

FIG. 4 is a conceptual diagram illustrating scenarios of direct communication between terminals based on a mobile communication network;

FIG. 5 is a conceptual diagram illustrating network interfaces of a mobile communication network-based vehicle communication system;

FIGS. 6A and 6B are conceptual diagrams for describing examples of radio protocol configurations of a terminal for direct communication using a sidelink radio channel; and

FIG. 7 is a sequence chart illustrating an exemplary embodiment of a method for sidelink communication between terminals according to sidelink resource allocation in the mode 1 scheme.

FIG. 8 is a sequence chart illustrating an exemplary embodiment of a method for sidelink communication between terminals according to sidelink resource allocation in the mode 2 scheme.

FIG. 9 is a conceptual diagram illustrating a SL-DRX-based low-power operation method of a terminal supporting a direct communication function according to an exemplary embodiment of the present disclosure.

FIG. 10 is a conceptual diagram illustrating a SL-WUS signaling-based low-power operation method of a terminal supporting a direct communication function according to an exemplary embodiment of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

While the present disclosure is susceptible to various modifications and alternative forms, specific embodiments are shown by way of example in the drawings and described in detail. It should be understood, however, that the description is not intended to limit the present disclosure to the specific embodiments, but, on the contrary, the present disclosure is to cover all modifications, equivalents, and alternatives that fall within the spirit and scope of the present disclosure.

Although the terms “first,” “second,” etc. may be used herein in reference to various elements, such elements should not be construed as limited by these terms. These terms are only used to distinguish one element from another. For example, a first element could be termed a second element, and a second element could be termed a first element, without departing from the scope of the present disclosure. The term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directed coupled” to another element, there are no intervening elements.

The terminology used herein is for the purpose of describing particular embodiments only and is not intended to be limiting of embodiments of the present disclosure. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, parts, and/or combinations thereof, but do not preclude the presence or addition of one or more other features, integers, steps, operations, elements, parts, and/or combinations thereof.

Unless otherwise defined, all terms (including technical and scientific terms) used herein have the same meaning as commonly understood by those of ordinary skill in the art to which the present disclosure pertains. It will be further understood that terms defined in commonly used dictionaries should be interpreted as having a meaning that is consistent with their meaning in the context of the related art and will not be interpreted in an idealized or overly formal sense unless expressly so defined herein.

Hereinafter, exemplary embodiments of the present disclosure will be described in greater detail with reference to the accompanying drawings. To facilitate overall understanding of the present disclosure, like numbers refer to like elements throughout the description of the drawings, and description of the same component will not be reiterated.

A communication system to which exemplary embodiments according to the present disclosure are applied will be described. The communication system may be the 4G communication system (e.g., Long-Term Evolution (LTE) communication system or LTE-A communication system), the 5G communication system (e.g., New Radio (NR) communication system), or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

A wireless communication network to which exemplary embodiments according to the present disclosure are applied will be described. The wireless communication network to which the exemplary embodiments according to the present disclosure are applied is not limited to the contents described below, and the exemplary embodiments according to the present disclosure may be applied to various wireless communication networks. Here, the wireless communication network may be used in the same sense as a wireless communication system.

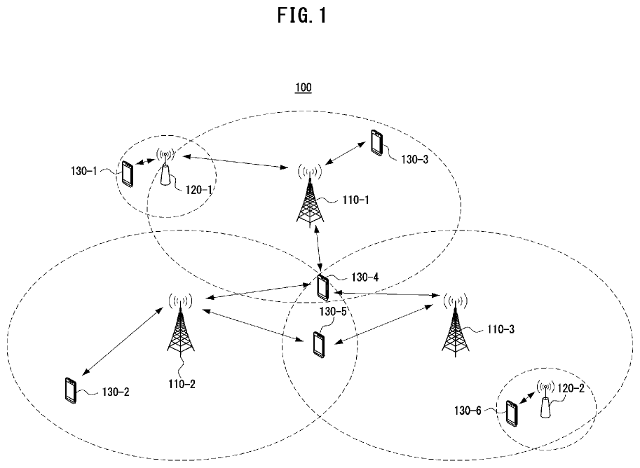

FIG. 1 is a conceptual diagram illustrating a first exemplary embodiment of a wireless communication network.

Referring to FIG. 1, a wireless communication network 100 may comprise a plurality of communication nodes 110-1, 110-2, 110-3, 120-1, 120-2, 130-1, 130-2, 130-3, 130-4, 130-5, and 130-6. Each of the plurality of communication nodes may support at least one communication protocol. For example, each of the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a space division multiple access (SDMA) based communication protocol, or the like. Each of the plurality of communication nodes may have the following structure.

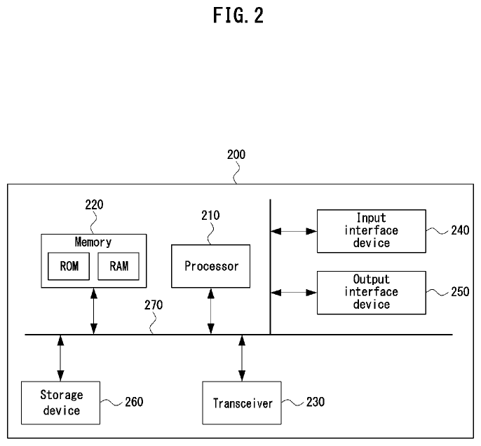

FIG. 2 is a block diagram illustrating a first exemplary embodiment of a communication node constituting a wireless communication network.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the wireless communication network 100 may comprise a plurality of base stations 110-1, 110-2, 110-3, 120-1, and 120-2, and a plurality of user equipments (UEs) 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third UE 130-3, and the fourth UE 130-4 may belong to cell coverage of the first base station 110-1. The second UE 130-2, the fourth UE 130-4, and the fifth UE 130-5 may belong to cell coverage of the second base station 110-2. Also, the fifth base station 120-2, the fourth UE 130-4, the fifth UE 130-5, and the sixth UE 130-6 may belong to cell coverage of the third base station 110-3. The first UE 130-1 may belong to cell coverage of the fourth base station 120-1. The sixth UE 130-6 may belong to cell coverage of the fifth base station 120-2.

Here, each of the plurality of base stations 110-1, 110-2, 110-3, 120-1 and 120-2 may refer to a node B (NodeB), an evolved NodeB (eNB), a base transceiver station (BTS), a radio base station, a radio transceiver, a transmission and reception point (TRP), an access point, an access node, or the like. Each of the plurality of UEs 130-1, 130-2, 130-3, 130-4, 130-5 and 130-6 may refer to a terminal, an access terminal, a mobile terminal, a station, a subscriber station, a mobile station, a portable subscriber station, a node, a device, or the like.

Each of the plurality of communication nodes 110-1, 110-2, 110-3, 120-1, 120-2, 130-1, 130-2, 130-3, 130-4, 130-5, and 130-6 may support a cellular communication (e.g., long term evolution (LTE), LTE-A (advanced), etc. defined in the 3rd generation partnership project (3GPP) standard), or wireless protocol specifications of mmWave (e.g., 6 GHz to 80 GHz band) based wireless access technology. Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network (not shown) through the ideal or non-ideal backhaul. Each of the plurality of base stations 110-1, 110-2, 110-3, 120-1, and 120-2 may transmit a signal received from the core network to the corresponding UE 130-1, 130-2, 130-3, 130-4, 130-5, or 130-6, and transmit a signal received from the corresponding UE 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, a device-to-device (D2D) communication (or, proximity services (ProSe)), or the like. Here, each of the plurality of UEs 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth UE 130-4 in the SU-MIMO manner, and the fourth UE 130-4 may receive the signal from the second base station 110-2 in the SU-MIMO manner. Alternatively, the second base station 110-2 may transmit a signal to the fourth UE 130-4 and fifth UE 130-5 in the MU-MIMO manner, and each of the fourth UE 130-4 and fifth UE130-5 may receive the signal from the second base station 110-2 in the MU-MIMO manner. Each of the first base station 110-1, the second base station 110-2, and the third base station 110-3 may transmit a signal to the fourth UE 130-4 in the CoMP transmission manner, and the fourth UE 130-4 may receive the signal from the first base station 110-1, the second base station 110-2, and the third base station 110-3 in the CoMP manner. Each of the plurality of base stations 110-1, 110-2, 110-3, 120-1, and 120-2 may exchange signals with the corresponding UEs 130-1, 130-2, 130-3, 130-4, 130-5, or 130-6 which belongs to its cell coverage in the CA manner. Each of the base stations 110-1, 110-2, and 110-3 may coordinate D2D communications between the fourth UE 130-4 and the fifth UE 130-5, and thus the fourth UE 130-4 and the fifth UE 130-5 may perform the D2D or V2X services under coordination of each of the second base station 110-2 and the third base station 110-3.

Hereinafter, operation methods of communication nodes in a mobile communication network will be described. Even when a method (e.g., transmission or reception of a signal) to be performed in a first communication node among communication nodes is described, a corresponding second communication node may perform a method (e.g., reception or transmission of the signal) corresponding to the method performed in the first communication node. That is, when an operation of a terminal is described, a corresponding base station may perform an operation corresponding to the operation of the terminal. Conversely, when an operation of the base station is described, the corresponding terminal may perform an operation corresponding to the operation of the base station.

In the following description, the SGW is a termination node of a core network for exchanging data packets with a base station providing services to a user terminal using a radio access protocol. Also, the MME is an entity in charge of a control function in a radio access section (or interface) for user terminals in a wireless communication network. Thus, in the following description, the present disclosure is not limited to the specific terms ‘SGW’ or ‘MME’. That is, the above-described terms may be replaced with other terms indicating a function that supports a radio access protocol according to a radio access technology (RAT) or an entity that performs the corresponding function according to a configuration of the core network.

When a dual connectivity function is supported, the terminal may configure connections with a plurality of base stations and receive services from the plurality of connected base stations. According to roles of the base stations supporting the dual connectivity function for the terminal, the base stations may be classified into a master base station and a secondary base station(s). Hereinafter, ‘dual connectivity’ may include dual connectivity using multiple base stations using the same radio access technology (RAT) and dual connectivity using multiple base stations using different RATs (e.g., MR-DC: Multi-Radio Dual Connectivity).

Here, the master base station (or node) may refer to a node that mainly performs a radio resource control (RRC) function and supports a control plane connection function with a core network in order to support the dual connectivity function. The master node may be composed of a plurality of cells, and the plurality of cells constituting the master node may be referred to as a ‘master cell group (MCG)’. An MCG bearer means a bearer that follows only the logical channel configuration of radio link control (RLC) and MAC layers of the cell belonging to the MCG.

In addition, the secondary base station (or node) may refer to a node that does not support a control plane connection function with the core network, and provides a service by using additional radio resources to the terminal in order to support the dual connectivity function. The secondary node may be composed of a plurality of cells, and the plurality of cells constituting the secondary node may be referred to as a ‘secondary cell group (SCG)’. The SCG bearer means a bearer that follows only the logical channel configuration of RLC and MAC layer of the cell belonging to the SCG.

Meanwhile, a split bearer may be a bearer that uses both the logical channel configurations of the MAC and RLC layers of the MCG and SCG. The split bearer may be classified into a secondary node (SN) terminated bearer or a master node (MN) terminated bearer according to the type of node performing a packet data convergence protocol (PDCP) function. The MN terminated bearer is a bearer in which the PDCP function for the corresponding bearer is performed in the master node, and the SN terminated bearer is a bearer in which the PDCP function for the corresponding bearer is performed in the secondary node.

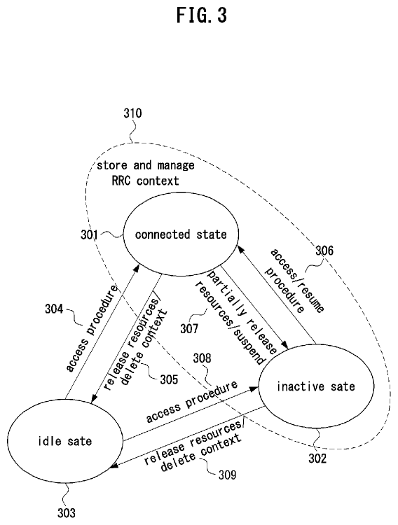

FIG. 3 is a state transition diagram for describing an example of state management for a terminal applied to exemplary embodiments of the present disclosure.

The terminal may operate in a connected state 301, an inactive state 302, or an idle state 303 according to a connection configuration state with the base station providing services. The terminal in the connected state 301 and the inactive state 302 may store and manage RRC context information together with the base station (310). When the terminal transitions to the idle state 303 through a procedure 305 or 309, the RRC context information may be deleted. Here, the RRC context information may include an identifier assigned to the corresponding terminal, and may additionally include parameters configured for protocol data unit (PDU) session information, security key, capability information, and the like.

The terminal in the idle state 303 may monitor a downlink signal or perform a measurement operation in an on-duration or an active time according to a discontinuous reception (DRX) cycle configured for a low power consumption operation, so as to perform a cell selection or reselection operation to camp on an optimal base station (or, cell). The terminal may acquire system information to camp on a new cell. The terminal may request required system information when necessary. In addition, the terminal may perform an operation for receiving a downlink paging message in the on-duration or the active time according to configured paging occasions.

The terminal in the connected state 301 may establish a radio bearer (e.g., a data radio bearer (DRB) or a signal radio bearer (SRB)) with the serving cell (or base station) and store and manage RRC context information required in the connected state. The terminal in the connected state may monitor a physical downlink control channel (PDCCH) by using the stored and managed RRC context information and connection configuration information from the base station, and receive a downlink packet scheduled and transmitted by the serving cell or transmit a packet to the serving cell by using uplink grant information. The mobility function for the terminal in the connected state 301 may be performed through a handover procedure when the cell is changed. For such the handover procedure, the terminal may perform a measurement operation on the serving cell or neighbor cells according to measurement or reporting parameters configured by the serving cell, and report the result to the serving cell. In addition, the terminal in the connection state 301 may perform the DRX operation according to DRX operation configuration parameters for the connection state configured by the serving cell. The terminal in the connected state 301 performing the DRX operation may perform a PDCCH monitoring operation in the on-duration or the active time according to the DRX cycle.

The terminal in the inactive state 302 may store and manage RRC context information required in the inactive state. The terminal in the inactive state 302 or the idle state 303 may perform the DRX operation according to the DRX parameters configured by the last serving cell. Depending on the DRX cycle, the terminal may perform a cell selection or reselection operation for camping on an optimal base station (or cell) by monitoring a downlink signal or performing a measurement operation in the on-duration or the active time. The terminal may acquire system information to camp on a new cell. The terminal may request required system information when necessary. In addition, the terminal in the inactive state or the idle state may perform an operation for receiving a downlink paging message in the on-duration or the active time according to configured paging occasions.

A beamforming technique may be applied for transmission and reception through a radio link between the base station (or cell) and the terminal. A signal transmitted by the terminal may be used to provide mobility between base stations or to select an optimal beam within the base station. The terminal may be provided with services by configuring a connection(s) with one or more cells (or base stations). Alternatively, the terminal may exist in a service area of the corresponding base station in a state in which only connection configuration is maintained (e.g., state in which access stratum (AS) context information is stored and managed) or in a state in which the terminal does not have connection configuration.

In the mobile communication system using the base station to which the beamforming technique is applied in a high frequency band, a beam level mobility support function that changes a configured beam of the terminal within the base station, and a mobility support and radio resource management function that changes the configured beam and radio link configuration between base stations (or cells) may be considered.

In order to perform the mobility support and radio resource management function, the base station may transmit a synchronization signal or a reference signal for the terminal to search or monitor. In case of a base station using a frame format supporting a plurality of symbol lengths to support multi-numerology, monitoring by the terminal may be performed for a synchronization signal or a reference signal configured with an initial numerology, default numerology, or default symbol length. Here, the initial numerology or the default numerology may be a configuration of a frame format applied to radio resources in which a UE-common search space is configured, a frame format applied to radio resources in which a control resource set (CORESET) ZERO (or, CORESET #0) of physical downlink control channels of the 3GPP new radio access technology (New RAT, NR) system is configured, or a frame format applied to radio resources through which a synchronization symbol burst for identifying a cell in the 3GPP NR system is transmitted.

Here, the frame format may refer to information on configuration parameters (e.g., values of the configuration parameters, offset, index, identifier, range, periodicity, or interval (or, duration), etc.) such as a subcarrier spacing (SCS) configuring a radio frame (or subframe), a control channel configuration (e.g., configuration of CORESET), a symbol (or slot) configuration, a reference signal configuration, or the like. The information on the frame format may be transferred to the terminal using system information or a dedicated control message.

In addition, the terminal, which has configured a connection with the base station, may perform a beam management operation by monitoring a configured beam or an activated beam through transmission of an uplink dedicated reference signal configured by the base station or reception of a downlink dedicated reference signal configured by the base station.

For example, the base station may transmit a synchronization signal (SS) and/or a downlink reference signal so that terminals in its service coverage can search for itself to perform downlink synchronization maintenance, beam configuration, or radio link monitoring operations. Also, the terminal, which has configured a connection with the serving base station, may receive physical layer radio resource configuration information for connection configuration and radio resource management from the serving base station.

Here, the physical layer radio resource configuration information may mean configuration parameters in RRC control messages of the LTE or NR system, such as PhysicalConfigDedicated, PhysicalCellGroupConfig, PDCCH-Config, PDCCH-ConfigSIBI, ConfigCommon, PUCCH-Config, BWP-Downlink, BWP-Uplink, RACH-ConfigCommon, RACH-ConfigDedicated, RadioResourceConfigCommon, RadioResourceConfigDedicated, ServingCellConfig, ServingCellConfigCommon, or the like, and may include the following information. The configuration information may include parameter values such as a configuration (or allocation) periodicity of a corresponding signal (or radio resource) based on a frame format of a base station (or transmission frequency), position information of a radio resource for transmission in a time domain/frequency domain, a transmission (or allocation) time, or the like. Here, the frame format of the base station (or transmission frequency) may mean a frame format having a plurality of symbol lengths according to a plurality of SCS within one radio frame to support multi-numerology. That is, the number of symbols constituting minislots, slots, and subframes that exist within one radio frame (e.g., a frame of 10 ms) may be configured differently.

(1) Configuration Information of Transmission Frequency and Frame Format of base station
Transmission frequency information: information on all transmission carriers (i.e., cell-specific transmission frequency) in the base station, information on BWPs in the base station, information on a transmission time reference or time difference between transmission frequencies in the base station (e.g., transmission periodicity or offset parameter indicating the transmission reference time (or time difference) of the synchronization signal), etc.
Frame format information: configuration parameters of a minislot, slot, subframe that supports a plurality of symbol lengths according to SCS.

(2) Configuration information of downlink reference signal (e.g., channel state information-reference signal (CSI-RS), common reference signal (Common-RS), etc.)
Configuration parameters such as a transmission periodicity, a transmission position, a code sequence, or a masking (or scrambling) sequence for a reference signal commonly applied in the coverage of the base station (or beam).

(3) Configuration information of uplink control signal
Configuration parameters such as a sounding reference signal (SRS), uplink beam sweeping (or beam monitoring) reference signal (RS), uplink grant-free radio resources, or uplink radio resources (or RA preamble) for random access, etc.

(4) Configuration information of physical downlink control channel (PDCCH)
Configuration parameters such as a reference signal for PDCCH demodulation, a beam common reference signal (e.g., a reference signal that can be received by all terminals in a beam coverage), a beam sweeping (or beam monitoring) reference signal, a reference signal for channel estimation, etc.

(5) Configuration information of physical uplink control channel (PUCCH)

(6) Scheduling request signal configuration information

(7) Configuration information for a feedback (ACK or NACK) transmission resource for supporting HARQ functions, etc.

(8) Number of antenna ports, antenna array information, beam configuration or beam index mapping information for application of beamforming techniques

(9) Configuration information of downlink and/or uplink signals (or uplink access channel resource) for beam sweeping (or beam monitoring)

(10) Configuration information of parameters for beam configuration, beam recovery, beam reconfiguration, or radio link re-establishment operation, a beam change operation within the same base station, a reception signal of a beam triggering handover execution to another base station, timers controlling the above-described operations, etc.

(11) A bandwidth part (BWP) index indicating a BWP within a system bandwidth, which is for delivering signaling information and data between the base station and the terminal, or between the terminals, and configuration information of PDCCH/PDSCH, a subcarrier spacing (SCS) parameter, etc. constituting the BWP

In case of a radio frame format that supports a plurality of symbol lengths for supporting multi-numerology, the configuration (or allocation) periodicity of the parameter constituting the above-described information, the time-domain and frequency-domain position information of the radio resource, or the transmission (or allocation) time may be information configured for each corresponding symbol length (or subcarrier spacing).

In the following description, ‘Resource-Config information’ may refer to a control message for radio resource configuration including at least one parameter among the above-described physical layer radio resource configuration information. In the following description, a property or setting value (or range) of an information element (or parameter) transmitted by the corresponding control message may have a meaning, rather than the name of ‘Resource-Config information’. Thus, the information element (or parameter) conveyed by the Resource-Config control message may be radio resource configuration information which is commonly applied to the entire base station (or beam) coverage or dedicatedly allocated to a specific terminal (or terminal group). The configuration information of the above-described Resource-Config information may be configured as one control message or may be configured as different control messages according to the property of the configuration information. In addition, the beam index may be represented without distinction between transmission beam indexes and reception beam indexes by using an index (or identifier) of a reference signal mapped or associated with the corresponding beam, or an index (or identifier) of a transmission configuration indicator (TCI) state for beam management.

Therefore, the terminal in the connected state may be provided with services through a beam configured with the serving cell (or base station). The terminal may search or monitor a downlink radio channel by using a downlink synchronization signal (e.g., synchronization signal/physical broadcast channel (SS/PBCH) block of the 3GPP NR system) or a downlink reference signal (e.g., channel state information-reference signal (CSI-RS) of the NR system) of the serving cell. Here, that the beams are configured (or beam paired) and services are provided may mean that packets are transmitted or received through an activated beam among one or more configured beams. In the 3GPP NR system, activation of a beam may mean that a configured TCI state is activated.

In addition, when the terminal is in an idle state or an inactive state, the terminal may search for or monitor a downlink radio channel using parameters obtained or configured from the system information or common Resource-Config information. Further, the terminal may attempt access or transmit control information using an uplink channel (e.g., a random access channel or a physical layer uplink control channel).

Through such the radio link monitoring (RLM) operation, the terminal may detect a radio link problem. Here, the detection of a radio link problem means that there is an error in configuring or maintaining physical layer synchronization for the corresponding radio link. That is, this means that it is detected that the physical layer synchronization of the terminal has not been maintained for a certain time. When a radio link problem is detected, a radio link recovery operation may be performed. If the radio link problem is not recovered, a radio link failure (RLF) may be declared, and a radio link re-establishment procedure may be performed.

A physical layer (Layer 1 or physical layer), Layer 2 functions such as Medium Access Control (MAC), Radio Link Control (RLC), Packet Data Convergence Protocol (PDCP), etc., or Layer 3 functions such as Radio Resource Control (RRC) of the radio protocol constituting the radio link may participate in the procedures such as the detection of a physical layer problem in a radio link, the radio link recovery, the radio link failure detection (or declaration), and the radio link re-establishment according to the radio link monitoring operation.

The physical layer of the terminal may receive a downlink synchronization signal and/or a reference signal (RS) to monitor the radio link. In this case, the reference signal may be a base station common reference signal (Common RS) or a beam common reference signal, or a dedicated reference signal allocated to the terminal (or terminal group). Here, the common reference signal refers to a reference signal that can be received by all terminals within the coverage (or service area) of the corresponding base station or beam to estimate a channel. In addition, the dedicated reference signal refers to a reference signal that can be received and used for channel estimation only by a specific terminal or terminal group within the coverage of the base station or the beam.

Therefore, when the base station or the configured beam is changed, the dedicated reference signal for managing the changed beam may be changed. This means that a procedure for selecting another beam from among the beams configured through the configuration parameters between the base station and the terminal or changing the configured beam is required. In the 3GPP-based NR system, changing the beam means that an index of another TCI state is selected among the indexes (or identifiers) of the configured TCI states or a new TCI state is configured and changed to an active state. Configuration information on the common reference signal may be obtained by the terminal through system information. Alternatively, in case of a handover in which the base station is changed or in case of connection reconfiguration, the base station may transmit the configuration information on the common reference signal to the terminal through a dedicated control message.

According to configuration conditions of the radio protocol layers of the base station (or cell), information for identifying the corresponding transmitting base station may be transferred to the terminal by using a control message of the RRC layer or the MAC layer, or a physical layer control channel. In this case, the information for identifying the transmitting base station (or transmission node) may include an identifier of the base station (or transmission node), reference signal information, information on a configured beam (or configured TCI state), information on a sequence (or scrambling) identifier for the base station (or transmission node), or the like.

The reference signal information may be a radio resource of a reference signal allocated for each transmitting base station, sequence information or index information of the reference signal, or sequence information or index information of a dedicated reference signal allocated to the terminal. Here, the radio resource of the reference signal may mean parameters indicating a symbol position on a time axis at which the reference signal is transmitted and a relative or absolute subcarrier position on a frequency axis within a radio resource region such as a frame, subframe, or slot. Such the parameter may be represented by a number or the like sequentially assigned to index, symbol, or subcarrier, which represents a corresponding radio resource element or radio resource set. Hereinafter, the reference signal information may refer to the above-described transmission periodicity, the code sequence or masking (or scrambling) of the reference signal, the radio resource of the reference signal, index information, or the like. The reference signal identifier may refer to a parameter (e.g., resource ID, resource set ID) that can distinguish the corresponding reference signal information uniquely among one or more reference signal information.

The information on the configured beam may be an index (or identifier) of the configured beam (or configured TCI state), configuration information of the corresponding beam (e.g., transmission power, beam width, vertical/horizontal angle, etc.), transmission or reception timing information (e.g., an index or an offset value of subframe, slot, minislot, symbol, etc.) of the corresponding beam, or reference signal information or reference signal identifier information corresponding to the corresponding beam.

In addition, the base station may be installed in the air such as a drone, an aircraft, or a satellite to perform the operation of the base station described in the present disclosure.

Accordingly, the terminal may identify a target base station (or transmission node) to perform a beam monitoring operation, a radio access operation, or a transmission/reception operation of a control (or data) packet by using identification information of the transmitting base station (or transmission node), which the base station transmits using the control message of the RRC layer or the MAC layer, or the physical layer control channel.

In addition, where a plurality of beams are configured to the terminal, the base station and the terminal may transmit and receive packet information with all the configured beams, and the number of downlink beams may be the same as or different from the number of uplink beams. For example, a plurality of downlink beams from the base station to the terminal may be configured, and one uplink beam from the terminal to the base station may be configured.

Based on the terminal's report on results of beam measurement or beam monitoring, the base station may change the property (e.g., primary beam, secondary beam, reserved (or candidate) beam, active beam, or deactivated beam) of the beam (or property of the TCI state). Here, when the TCI state is changed, the property of the TCI state may be changed to a primary TCI state, a secondary TCI state, a reserved (or candidate) TCI state, a configured TCI state, an active TCI state, a deactivated TCI state, or the like.

As described above with respect to the property of the TCI state, a state in which a data packet or control signaling can be transmitted or received even in a limited manner, such as the primary TCI state or the secondary TCI state, may be assumed as the active TCI state or a serving TCI state. Also, a state in which it is a target of measurement or management, but data packets or control signaling cannot be transmitted or received, such as the reserved (or candidate) TCI state, may be assumed as the deactivated TCI state or configured TCI state.

The change of the property of the beam (or TCI state) may be controlled at the RRC layer or the MAC layer. When changing the property of the beam (or TCI state) at the MAC layer, the MAC layer may notify the higher layer of the beam property change. In addition, the change of beam property may be transferred to the terminal using a control message of the MAC layer or a physical layer control channel (e.g., a physical downlink control channel (PDCCH) of the LTE (or NR) system). Here, when the physical layer control channel is used, the control information may be configured in form of downlink control information (DCI), uplink control information (UCI), or a separate indicator (or field information) of the LTE (or NR) system.

The terminal may request to change the TCI state property based on the beam measurement or monitoring results. The control information or feedback information for requesting the change of the TCI state property may be transmitted using a physical layer control channel, a MAC layer control message, or an RRC control message. The control message, signaling information, or feedback information for changing the TCI state property may be configured using at least one or more parameters from the above-described information on configured beam.

The property change of the beam (or TCI state) described above may mean a change from the active beam to the deactivated beam or reserved (or candidate) beam, or a change from the primary beam to the secondary beam or reserved (or candidate) beam, or vice versa. That is, it means that the property of the beam is changed between the beam properties described above, and the change of beam property may be performed in the RRC layer or the MAC layer. If necessary, the beam property change may be performed through partial cooperation between the RRC layer and the MAC layer.

In addition, when a plurality of beams are allocated, a beam for transmitting a physical layer control channel may be configured and operated. That is, a physical layer control channel may be transmitted using all the multiple beams (e.g., the primary beam or the secondary beam) or a physical layer control channel may be transmitted using only the primary beam.

Here, the physical layer control channel is a channel such as PDCCH or PUCCH of the LTE (or NR) system, and may transmit scheduling information including radio resource element (RE) allocation and modulation and coding scheme (MCS) information, channel quality indication (CQI), precoding matrix indicator (PMI), feedback information such as HARQ ACK/NACK, resource request information such as scheduling request (SR), beam monitoring result (or TCI state ID) for supporting beamforming function, measurement information on active or inactive beams, or the like.

In the above description, the radio resource may be configured by frequency-axis parameters such as center frequency, system bandwidth, subcarriers, or the like and time-axis parameters according to a unit of transmission (or reception) time (or, periodicity, interval, window) such as radio frame, subframe, transmission time interval (TTI), slot, minislot, symbol, or the like. Additionally, the radio resource may refer to a resource occupied for transmission in the radio section by applying a hopping pattern of the radio resource, a beam forming technique using multiple antennas (e.g., beam configuration information, beam index), or a code sequence (or bit sequence or signal sequence). In case of such the radio resource, the name of the physical layer channel (or transport channel) may vary according to the type (or property) of data or control message to be transmitted, uplink, downlink, sidelink (or side channel), or the like.

Such the reference signal for beam (or TCI state) or radio link management may include a synchronization signal such as a synchronization signal (SS) or a synchronization signal block (SSB), a channel state information reference signal (CSI-RS), a phase tracking (PT-RS), a sounding reference signal (SRS), a demodulation reference signal (DM-RS), or the like. A reference parameter for reception quality of the reference signal for beam (or TCI state) or radio link management may be configured as a parameter such as a measurement unit time, a measurement interval, a reference value indicating a degree of improved change, a reference value indicating a degree of deteriorated change, or the like. The measurement unit time or measurement interval may be configured as an absolute time reference (e.g., ms, sec, etc.), transmission timing interval (TTI), a radio channel configuration such as symbol, slot, (sub)frame, scheduling periodicity, etc., an operation periodicity of the base station or terminal, or the like. Also, the reference value representing the degree of change in reception quality may be configured as an absolute value (dBm) or a relative value (dB). Also, the reception quality of the reference signal for beam (or TCI state) or radio link management may be represented by Reference Signal Received Power (RSRP), Reference Signal Received Quality (RSRQ), Received Signal Strength Indicator (RSSI), Signal-to-Noise Ratio (SNR), Signal-to-Interference Ratio (SIR), or the like.

Meanwhile, in the 3GPP NR system using the millimeter frequency band, a bandwidth part (BWP) concept is applied to secure flexibility of operating a channel bandwidth for packet transmission. The base station may configure up to four BWPs having different bandwidths to the terminal. The BWPs may be configured independently for downlink and uplink. Each BWP may have not only a different bandwidth but also a different subcarrier spacing (SCS).

For example, the terminal in the connected state 301 described in FIG. 3 may measure signal qualities of radio links for the serving cell or cells that are measurement objects (e.g., neighbor cell, target cell, candidate cell, and the like) based on synchronization signal/physical broadcast channel (SS/PBCH) blocks or CSI-RS. Here, the signal quality may be expressed by RSRP, RSRQ, RSSI, SNR, SIR, or SINR, which are referred to as the reception performance of the reference signal for radio link management or the beam (or TCI state) described above.

In addition, the terminal in the inactive state 302 or the idle state 303 of FIG. 3 may measure signal qualities (e.g., RSRP, RSRQ, SINR, RSSI, or the like) of radio links for the serving cell (or camped cell) or neighbor cells according to a configured DRX cycle (e.g., measurement cycle) based on the SS/PBCH blocks. The terminal may perform a cell selection or reselection operation based on the measurement result. For the measurement on the serving cell (or camped cell), the terminal may obtain, through system information of the corresponding cell, information on a transmission periodicity (e.g., ssb-PeriodicityServingCell information) of the acquired SS/PBCH block or configuration information (e.g., ssb-PositionslnBurst information) of radio resources through which the SS/PBCH block is transmitted. In addition, for the measurement on the neighbor cells, the terminal may acquire signal measurement time configuration (SMTC) window information through the system information. When the terminal in the inactive state 302 or the idle state 303 performs the cell selection or reselection operation based on the measurement of the SS/PBCH blocks, if a change in a radio access network (RAN) area or a tracking area (TA) is recognized, the terminal may perform a RAN area or tracking area update procedure.

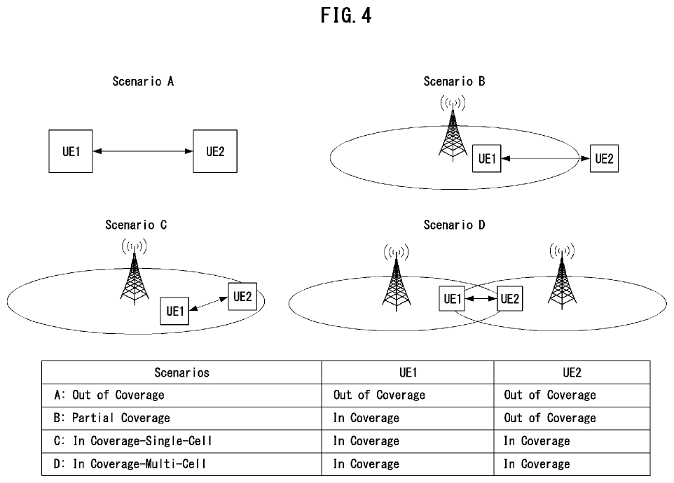

FIG. 4 is a conceptual diagram illustrating scenarios of direct communication between terminals based on a mobile communication network.

In FIG. 4, in support of a direct communication function based on a mobile communication network, scenarios for direct communication, which are related to coverages of cells (or, base stations (Node B), access points (APs), transmission and reception points (TRPs), etc.), are shown.

As shown in FIG. 4, a scenario A is a case in which there is no mobile communication cell (or base station, node, etc.) capable of providing services to terminals (i.e., UE1 and UE2) performing direct communication. Such the case is classified as an ‘out-of-coverage’ case, and in this case, resource allocation and control signaling for direct communication may be performed in a distributed control scheme.

Scenarios C and D are cases in which terminals (i.e., UE1 and UE2) performing direct communication are located in a service coverage of an arbitrary cell (or base station, AP, node, etc.) capable of providing services. The scenario C is a case in which terminals (i.e., UE1 and UE2) performing direct communication are located in a service coverage of the same cell (or node) (i.e., ‘in coverage-single-cell’ case). The scenario D is a case in which terminals (i.e., UE1 and UE2) performing direct communication are located in service coverages of different cells (or nodes) (i.e., ‘in coverage-multi-cell’ case).

The scenario B is a case in which one terminal (i.e., UE1) among terminals performing direct communication is located in a service coverage of a mobile communication cell and the other terminal (i.e., UE2) is located outside the service coverage of the mobile communication cell. Such the case may be classified as a ‘partial coverage’ case.

For allocation of radio resources for sidelink (SL) (or PC5 interface) between the terminals for direct communication, a base station control scheme or a distributed control scheme (or terminal determination scheme) may be applied according to configuration (or operation) of the mobile communication network.

The base station control scheme (or mode 1) is a scheme in which a base station allocates resources through scheduling. That is, a terminal performing direct communication based on the mode 1 may transmit control information and data for direct communication by using a sidelink radio resource allocated by the base station. That is, since the base station allocates resources from an available direct communication resource pool, control information and data can be transmitted without collision between terminals performing direct communication.

On the other hand, the distributed control scheme (or terminal determination scheme (or mode 2) is a scheme in which a terminal performing direct communication independently selects a transmission resource from a radio resource pool for direct communication, which is configured by a system (or, base station (or cell)), and transmits control information and data by using the selected transmission resource. Accordingly, the terminal performing direct communication based on the mode 2 can transmit control information and data by using a radio resource randomly selected from the radio resource pool for direct communication. Therefore, a collision may occur between sidelink radio resources used by terminals performing direct communication.

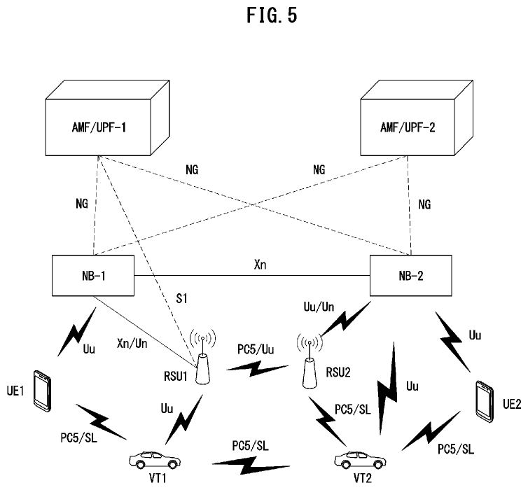

FIG. 5 is a conceptual diagram illustrating network interfaces of a mobile communication network-based vehicle communication system.

Base stations NB-1 and NB-2 may exchange packet messages, which are for a control plane in which control information is transmitted and received and a user plane in which traffic data is transmitted and received, through NG interfaces with an access and mobility management function (AMF) or a user plane function (UPF).

In addition, a road side unit (RSU) for the vehicle communication system may operate as a base station (or L2/L3 relay node) or as a terminal. An RSU (e.g., RSU1 in FIG. 5) operating as a base station (or L2/L3 relay node) may exchange packet information with the base station through an Xn interface (or, Un interface, when the RSU is a relay node). Also, the RSU may exchange packet information with the AMF (or UPF) through an NG interface. The NG interface is a logical interface and may be physically connected to the AMF (or UPF) via the base station.

On the other hand, an RSU (e.g., RSU2 in FIG. 5) operating as a terminal may exchange packet information with the base station through a Uu interface (or, Un interface, when the RSU is a relay node).

In addition, a radio section between the RSUs (e.g., RSU1 and RSU2) may exchange packet information by using a PC5 interface for direct communication or a Uu interface between base station and terminal.

In addition, packet information may be exchanged among user terminals UE1 and UE2 and vehicle terminals VT1 and VT2 through a PC5 interface for direct communication (i.e., radio resources or radio channels of a sidelink). In particular, the PC5 interface for direct communication among the user terminals UE1 and UE2 and the vehicle terminals VT1 and VT2 may be an interface for device-to-device (D2D) or V2X communication for an existing user terminal of the 3GPP LTE/LTE-A system. Alternatively, the PC5 interface may be a radio interface or a sidelink radio resource (or radio channel), which is newly defined in the 3GPP NR system or changed from that of the 3GPP NR system.

The vehicle terminal VT1 or VT2 may exchange packet information with the RSU (or layer3/layer2 (L3/L2) relay-type RSU) through a Uu interface (i.e., communication between VT1 and RSU1 in FIG. 5), or may exchange packet information with the base station (or L3/L2 relay-type node) through a Uu interface (i.e., communication between VT2 and NB-2 in FIG. 5). In the above description, ‘exchange of packet information’ may mean a process of transmitting or receiving control signaling or traffic data packets to each other.

Both of the above-described mode 1 and mode 2 schemes may be applied to resource allocation for direct communication between terminals. A termination node (e.g., cell, eNB, base station, AP, RSU, etc.) of the system may transmit configuration information of a direct communication pool for the mode 1 and mode 2 schemes to the terminals through system information or a dedicated control message.

The direct communication between terminals using a sidelink radio channel may be performed in a broadcast scheme, a groupcast scheme, and a unicast scheme. The broadcast scheme is a scheme in which a transmitting terminal transmits a sidelink radio channel to all terminals capable of receiving the sidelink radio channel. The groupcast scheme is a scheme in which only terminals belonging to a specific group can receive a sidelink radio channel transmitted by a transmitting terminal. In addition, the unicast scheme is a scheme in which a terminal supporting a direct communication function establishes a one-to-one connection with a specific terminal by using a sidelink radio channel and transmits or receives information to or from the specific terminal.

Configuration of Radio Protocols for Direct Communications

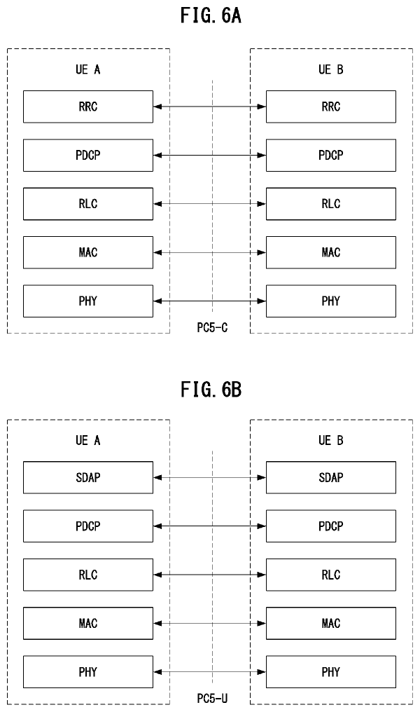

FIGS. 6A and 6B are conceptual diagrams for describing examples of radio protocol configurations of a terminal for direct communication using a sidelink radio channel.

As shown in FIG. 6A, a control plane for transmitting control information may comprise a radio resource control (RRC) layer, a packet data convergence protocol (PDCP) layer, a radio link control (RLC) layer, and a medium access control (MAC) layer, and a physical (PHY) layer. As shown in FIG. 6B, a user plane for transmitting traffic data may comprise a service data adaptation protocol (SDAP) layer, a PDCP layer, an RLC layer, a MAC layer, and a PHY layer.

As described above, as a radio resource allocation scheme for direct communication using a sidelink channel(s), the base station control scheme (or mode 1) in which a base station schedules a radio resource of a sidelink channel to a terminal by using a physical layer control channel (e.g., PDCCH or DCI), and the distributed control scheme (or mode 2) in which a terminal independently selects a transmission resource from a radio resource pool for direct communication configured by a system (or a base station (or cell)) may be used.

The mode 1 and/or mode 2 radio resource allocation may refer to allocating a time and/or frequency domain radio resource for a sidelink channel (e.g., PSCCH, PSSCH, or PSFCH). Here, the PSCCH is a physical layer sidelink control channel, and may deliver physical layer control information for direct communication. The PSSCH is a physical layer sidelink shared channel, and may deliver a data packet for direct communication. In addition, the PSFCH is a physical layer sidelink feedback channel, and may deliver HARQ feedback information for a received PSSCH.

In the sidelink radio resource allocation of the base station control scheme (or mode 1), the base station may use a radio resource control (RRC) control message such as RRCReconfigurationNR, sl-ConfigDedicatedNR, SL-ScheduledConfig, and/or SL-ConfiguredGrantConfig to allocate a sidelink channel radio resource to the terminal in a configured grant (CG) scheme or a semi-persistent scheduling (SPS) scheme. The base station control scheme (or mode 1) may be classified into a CG type 1 scheme and a CG type 2 scheme. The CG type 1 is a scheme in which an RRC layer of the base station directly allocates sidelink (SL) radio resources using an RRC control message. In addition, the CG type 2 scheme is a scheme in which the base station configures sidelink radio resources in the CG or SPS scheme using an RRC control message, and uses a MAC control element (CE) message or PDCCH (or DCI) to schedule or activate (or deactivate) a sidelink radio resource among the configured sidelink radio resources to the terminal.

On the other hand, in the sidelink radio resource allocation of the distributed control scheme (or mode 2), the base station (or a group of base stations belonging to the same zone) may use system information (SIB), and/or an RRC control message such as SL-ConfigCommonNR, NR-Sidelink-Preconfcommon, SL-FreqConfigcommon, SL-BWP-Configcommon, SL-BWP-PoolConfig(common), and/or SL-ResourcePool to deliver configuration information of a radio resource pool for sidelink channels to the terminal.

The RRC control message for the above-described CG or SPS-based mode 1 sidelink resource allocation and the system information or RRC control message for the mode 2 resource allocation (hereinafter, ‘sidelink resource allocation’ may refer to sidelink radio resource allocation or configuration according to the mode 1 or mode 2 scheme) may include one or more of the following information elements for sidelink channels (e.g., PSCCH, PSSCH, PSFCH) for direct communication.
Identifier indicating an allocated (or configured) sidelink resource or resource pool;
time domain sidelink resource allocation information;
frequency domain sidelink resource allocation information;
Modulation and coding information (e.g., modulation and coding scheme (MCS) configuration information)
HARQ configuration information (e.g., HARQ feedback transmission scheme, the number of HARQ processes, the maximum number of retransmissions, or PUCCH or PSFCH resource allocation information for HARQ feedback information transmission, etc.)

Here, the time domain sidelink resource allocation information may include a temporal allocation periodicity of a sidelink resource, a time resource location of a sidelink resource, and/or a time offset of the allocated sidelink resource. The time resource location of the sidelink resource may represent time information of the allocated sidelink resource in a form of a time resource indicator (TRI) or a bitmap, and the time information may be represented in units of a radio frame, a subframe, a slot, a minislot, or a symbol. In addition, the time offset of the allocated sidelink resource may refer to an offset with respect to a start reference point of the allocated sidelink resource in the time domain, or a relative offset with respect to a system frame number (SFN) reference (e.g., SFN=0).

In addition, the frequency domain sidelink resource allocation information may refer to a sidelink resource region (or the number (or range) of sidelink subchannels (or subcarriers) constituting the sidelink resource) in the frequency domain, the number of physical resource blocks (PRBs) constituting the sidelink resource, a start index of the sidelink subchannels (or subcarriers, resource blocks (RBs)), and/or the size of the sidelink subchannels (or a last index of the subchannels).

Meanwhile, common control information for providing a sidelink service, which includes the sidelink radio resource configuration information, may be configured on a validity area basis. Such a validity area may consist of one or more cells. The validity area for sidelink radio resource configuration may be identified by a sidelink validity area ID or other identifiers (e.g., cell identifier, tracking area ID, system information area ID, zone ID, or the like), or may be identified by a selective combination of the above-described identifier(s).

Sidelink configuration information for a sidelink BWP, CORESET, and/or sidelink radio resource pool for a sidelink service may be configured on a sidelink validity area basis. For example, if the sidelink validity area is changed, sidelink configuration information for a sidelink BWP, CORESET, and/or sidelink radio resource pool may be changed. Accordingly, even when a serving cell or a cell on which the terminal is camped is changed, if the sidelink validity area information (or sidelink validity area ID) maintains identically, the terminal may provide or receive the sidelink service by using the stored sidelink common configuration information or sidelink radio resource pool configuration information. However, when the validity area is changed, the terminal receiving the sidelink service or the terminal interested in the sidelink service may perform a procedure for updating the sidelink common configuration information or request transmission of system information necessary for acquiring sidelink common configuration information. Alternatively, if a terminal reports the change of the sidelink validity area to the base station, the base station may transmit new sidelink common configuration information to the terminal.

In direct communication using sidelink channels, a PC5-RRC connection establishment (configuration) between terminals is required for establishing or managing a radio link between the terminals for providing a unicast type service. For this, PC5-RRC control messages are exchanged between the terminals. The PC5-RRC message may include sidelink measurement object configuration information, sidelink measurement report configuration information, sidelink measurement quantity configuration information, access stratum (AS) configuration information for PC5-RRC connection (e.g., RRCReconfigurationSidelink message information), terminal (i.e., UE) capability information, and/or the like. The PC5-RRC messages exchanged between the terminals may not be delivered to the base station through a Uu interface (i.e., a radio interface between the base station and the terminal), or only limited control information of the PC5-RRC messages may be delivered to the base station.

When a transmitting terminal transmits a transport block (TB) (or code block) to a receiving terminal for direct communication, a field parameter within sidelink control information (SCI) may be used to identify a cast type (i.e., broadcast, groupcast, or unicast) of a corresponding MAC protocol data unit (PDU) or block. That is, the transmitting terminal may transmit cast type indication information (or, cast type indicator) to the receiving terminal by using the field parameter within the SCI. For example, when a 2-bit field parameter within the SCI is used, ‘00’ may indicate a broadcast type, ‘01’ may indicate a groupcast type, and ‘10’ may indicate a unicast type. In addition, the SCI may be transmitted as including a HARQ process number, a new data indicator (NDI), a source ID, a destination ID, HARQ enabled/disabled information, a zone identifier (i.e., zone ID), and/or the like. Based on the information included in the above-described SCI or a format of the SCI, it may be identified whether a HARQ feedback scheme is a ‘NACK-only feedback scheme’ of transmitting only NACK, ‘ACK/NACK feedback scheme’ of transmitting ACK or NACK, or ‘no ACK/NACK feedback scheme’ without transmission of ACK/NACK feedback information.

Radio resource allocation information of a sidelink feedback channel (PSFCH) for transmitting NACK or ACK feedback information may be delivered to the terminal by using an RRC layer control message for configuring a sidelink, a MAC control message for the sidelink, SCI, or a control message (or information) transmitted through a separate PSCCH. A mapping relationship with an associated PSFCH resource may be established based on the cast type indication information in the SCI. Here, the mapping relationship between the cast type indication information of the SCI and the PSFCH resource may determine an index of a PSFCH resource for transmitting feedback information for a received PSSCH according to the cast type indication information in the SCI. That is, according to the need of the HARQ feedback information transmission scheme (e.g., NACK-only feedback scheme or ACK/NACK feedback scheme), an index indicating a PSFCH radio resource for transmission of the HARQ feedback may be determined according to a HARQ process identifier, a L1 or L2 source ID, a L1 or L2 destination ID, and/or the cast type indication information.

That is, upon receiving the SCI including the cast type indication information, the terminal may obtain, from the information of the SCI, whether to transmit feedback information on the received PSSCH, whether to transmit NACK-only feedback or NACK or ACK feedback as feedback information, a location of the PSFCH resource for transmission of the feedback information, the index of the PSFCH resource, information indicating the mapping relationship between the cast type indication information of the SCI and the PSFCH resource, and/or the like.

In a low power consumption operation of the terminal supporting the direct communication function, the terminal may deliver, to the base station, information on whether the terminal is a terminal installed in a vehicle, whether the terminal is connected to an external (or additional) power supply, whether the terminal is a road side unit (RSU) device, whether the terminal is a non-vehicle terminal located in a busy street, or the like, by using a UE capability information transfer message, a sidelink service request message, a terminal assistant information transfer message (i.e., UEAssistanceInformation message), an RRC connection (re)configuration message, or a sidelink terminal information control message that the terminal transmits to the base station to obtain valid sidelink information.

Here, the sidelink terminal information control message for obtaining valid sidelink information may refer to an RRC control message (e.g., sidelinkUEinformationNR) including information on a sidelink service being provided to the terminal or a sidelink service in which the terminal is interested, destination ID, sidelink transmission or reception frequency (list), sidelink synchronization type, sidelink QoS profile/flow identifier, and/or the like. The information indicating whether the terminal is a non-vehicle terminal may be information indicating that the terminal is not either a terminal installed in a transportation means (e.g., car, train, etc.) or a terminal existing in a transportation means (or, a terminal of a user riding on the transportation means), but a general terminal of a user such as a pedestrian, etc.

For the low power consumption operation of the terminal supporting the direct communication function, the following procedures may be considered between the base station and the terminal and/or between the terminals.

The base station may configure mode 1 and/or mode 2 sidelink resource allocation information including one or more of the following SL-DRX parameters for the terminal supporting the direct communication function, and deliver the information to the terminal. In the following description, ‘SL-DRX’ may refer to a DRX operation for sidelink channels, and ‘DRX’ (i.e., ‘Uu DRX’) may refer to a DRX operation of Uu interface channels.
SL-DRX cycle
SL-DRX on-duration timer
SL-DRX inactivity timer
SL-DRX HARQ round-trip time (RTT) timer
SL-DRX retransmission timer
SL-DRX time offset

Here, the SL-DRX time offset may be information indicating a start point (e.g., information indicating a time domain start point such as a symbol or minislot/slot) of a SL-DRX on-duration for the sidelink DRX operation. The SL-DRX time offset may be configured in association with the above-described time domain sidelink resource allocation information (i.e., a temporal allocation periodicity of a sidelink resource, time resource location of the sidelink resource, or a time offset of the allocated sidelink resource). That is, the start point of the SL-DRX operation or the start point of the SL-DRX on-duration may be indicated based on the transmitting terminal or the receiving terminal for the SL-DRX operation. Therefore, the start point of the SL-DRX operation or the start point of the SL-DRX on-duration may be configured based on the identifier of the transmitting terminal (or terminal group) or the receiving terminal (or terminal group) performing the SL-DRX operation, or the cast type (or, case type indicator) of the terminal. Here, the identifier of the terminal (or terminal group) may be a scheduling identifier (e.g., XX-RNTI based on C-RNTI), a source ID, and/or a destination ID of the terminal. In addition, when one or more sidelink bearers are configured for the terminal, the above-described SL-DRX parameters may be configured for each sidelink bearer. Accordingly, all or part of the above-described SL-DRX parameters may be configured for each sidelink bearer identifier, sidelink scheduling identifier, source ID, and/or destination ID. Accordingly, one or more SL-DRX parameters or parameter sets (or list) may be configured to the terminal for the low power consumption operation of the terminal supporting the direct communication function.

The SL-DRX parameter in the sidelink resource allocation information may configured in form of a value for the corresponding SL-DRX parameter, a maximum configuration value of the corresponding SL-DRX parameter, a minimum configuration value of the corresponding SL-DRX parameter, or a range of configurable SL-DRX parameter values. In addition, the corresponding SL-DRX parameter may be applied by the terminal supporting the direct communication function for the DRX operation of radio channels for the sidelink and/or Uu interface.

The DRX parameters for the Uu DRX operation of the terminal and the DRX parameters for the SL-DRX operation may be configured to the same values or may be configured to be different values. When the DRX parameters for the Uu DRX operation and the DRX parameters for the SL-DRX operation are configured to be different values, the parameters for the Uu DRX operation may be set to multiples of the parameters for the SL-DRX operation, or the parameters for the Uu DRX operation and the parameters for the SL-DRX operation may be configured to have a predetermined offset or mapping relationship. Alternatively, when the SL-DRX cycle and the Uu DRX cycle are configured to be different values, the on-duration of the SL-DRX operation and the on-duration of the Uu DRX operation may overlap (e.g., full overlapping or partial overlapping). Alternatively, the on-duration (or active time) of the SL-DRX operation may include the on-duration (or active time) of the Uu DRX operation, or the on-duration (or active time) of the Uu DRX operation may include the on-duration (or active time) of the SL-DRX operation. Alternatively, the start point of the on-duration (or active time) of the SL-DRX operation may be configured to be aligned with the start point of the on-duration (or active time) of the Uu DRX operation at a specific periodic time. Here, the active time may refer to a period in which a reception or transmission operation on a corresponding channel occurs in the on-duration of the SL-DRX (or Uu DRX) operation, and a monitoring operation for the corresponding channel continues even after the corresponding on-duration timer expires. If a reception or transmission operation on the corresponding channel occurs within the on-duration or active time of the SL-DRX (or Uu DRX) operation, a SL-DRX inactivity timer starts, and the active time ends if no reception or transmission operation occurs until the SL-DRX inactivity time expires.

According to the above-described operation method, the Uu DRX operation and the SL-DRX operation of the terminal transmitting or receiving sidelink channels may be aligned in a full overlapping or partial overlapping manner.

PC5-RRC Connection Establishment

In order to provide a unicast service in direct communication using a sidelink radio channel, a procedure for establishing or managing a radio link between terminals is required.

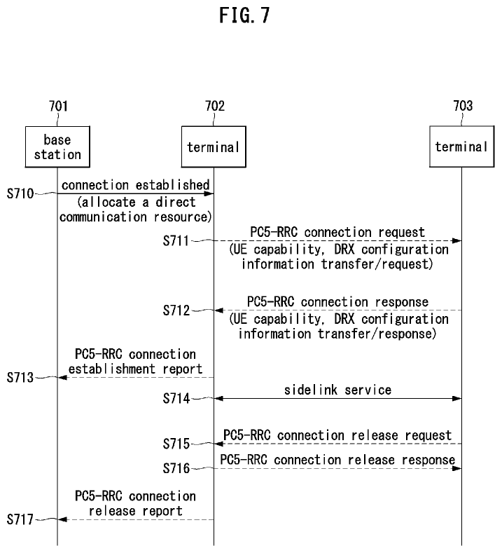

FIG. 7 is a sequence chart illustrating an exemplary embodiment of a method for sidelink communication between terminals according to sidelink resource allocation in the mode 1 scheme.

As shown in FIG. 7, a terminal 702 and a terminal 703 may be terminals subscribed to the same operator or terminals subscribed to different operators. In addition, the terminals 702 and 703 of FIG. 7 may be terminals installed in vehicles or other type user terminals (e.g., cellular phones, smart phones, machine type communication (MTC) terminals, or Internet of Thing (IoT) terminals, etc.). In addition, a base station 701 and the terminals 702 and 703 of FIG. 7 may exchange data packets or control signaling messages by using the interfaces shown in FIG. 5. For example, the base station 701 and the terminals 702 and 703 may use the Uu interface (i.e., radio access interface between the base station and the terminal) of the 3GPP LTE/LTE-A system or NR system. In addition, data packets or control signaling messages may be exchanged between the terminals by using a sidelink channel for direct communication (e.g., D2D or V2X direct communication).

The terminals 702 and 703 may perform a direct communication function in the connected state (e.g., RRC connected state), inactive state (e.g., RRC inactive state), or idle state (e.g., RRC idle state) described in FIG. 3. For example, the terminal 702 may establish a connection with the base station 701 and when necessary, the terminal 702 may be allocated resources for direct communication from the base station (i.e., resource allocation according to the above-described mode 1 scheme) (S710).

The terminal 702 configured with a sidelink resource for direct communication from the base station 701 may transmit a sidelink packet for a broadcast or groupcast service to the terminal 703. In order for the terminal 702 to provide a unicast service to the terminal 703 using sidelink channels, a PC5-RRC connection establishment procedure of steps S711 and S712 may be performed between the terminal 702 and the terminal 703. When a PC5-RRC connection is established between the terminal 702 and the terminal 703 through message exchange of the steps S711 and S712, the terminal 702 may provide a unicast service to the terminal 703 (S714). In addition, when the unicast service is terminated, the terminal 702 or the terminal 703 may trigger a PC5-RRC connection release to release the PC5-RRC connection through control message exchange of steps S715 and S716.

The step S713 of FIG. 7 in which the terminal 702 reports the PC5-RRC connection establishment to the base station 701 or a step S717 of FIG. 7 in which the terminal 702 reports the PC5-RRC connection release may or may not be selectively performed.

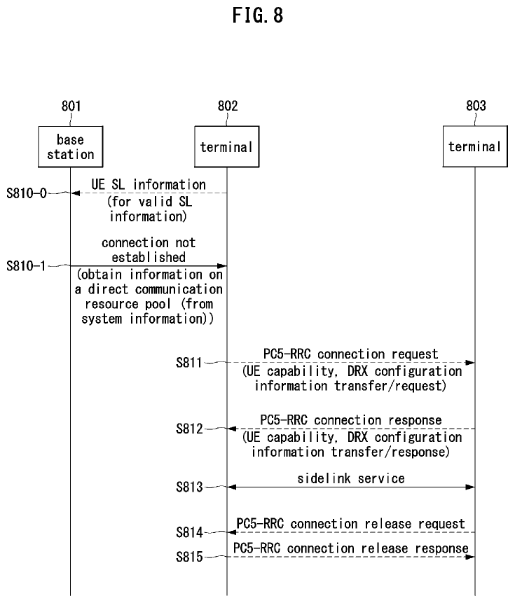

FIG. 8 is a sequence chart illustrating an exemplary embodiment of a method for sidelink communication between terminals according to sidelink resource allocation in the mode 2 scheme.

As shown in FIG. 8, a terminal 802 may camp on a base station 801, and may use system information received from the base station 801 without establishing an RRC connection with the base station 801 to obtain sidelink resource allocation information for direct communication (S810-1). When the terminal 802 recognizes (or identifies) that the sidelink resource allocation information obtained from the base station 801 is not valid information, the terminal 802 may transmit the above-described sidelink terminal information control message (or sidelinkUEinformationNR message) to the base station 801 (S810-0). Thereafter, the terminal 802 may receive valid SL resources for direct communication for the mode 2 scheme by using system information obtained from the base station 801 (S810-1). The terminal 802 may transmit a sidelink packet for a broadcast or groupcast service to the terminal 803.

Meanwhile, in order for the terminal 802 to provide a unicast service to the terminal 803 using sidelink channels, a PC5-RRC connection establishment procedure of steps S811 and S812 may be performed between the terminal 802 and the terminal 803. When a PC5-RRC connection is established between the terminal 802 and the terminal 803 through message exchange of the steps S811 and S812, the terminal 802 may provide a unicast service to the terminal 803 (S813). In addition, when the unicast service is terminated, the terminal 802 or the terminal 803 may trigger a PC5-RRC connection release to release the PC5-RRC connection through control message exchange of steps S814 and S815.

However, when the system does not allow a unicast service using a sidelink resource obtained according to the mode 2 scheme, the above-described PC5-RRC connection establishment procedure between the terminal 802 and the terminal 803 may not be performed. Accordingly, in this case, the steps S811 and S812 and the steps S814 and S815 of FIG. 8 may not be performed.

Sidelink DRX Configuration

In the low power consumption operation of the terminal supporting the direct communication function, the SL-DRX parameters may be configured by a different procedure according to the cast type of the direct communication service.

In case of a broadcast or groupcast service, the above-described SL-DRX parameters may be included in the sidelink resource allocation/configuration information allocated or configured by the base station in the mode 1 or mode 2 scheme. Alternatively, the base station may transmit configuration information of the SL-DRX parameters for the broadcast and/or groupcast service together with the sidelink resource allocation/configuration information to the terminal by using system information. The configuration information of the SL-DRX parameters for the broadcast and/or groupcast service may be a control message in a form of a list consisting of one or more SL-DRX parameter sets, or a control message indicating a range of each parameter for the SL-DRX operation or a plurality of values for each parameter for the SL-DRX operation. When the list consisting of one or more SL-DRX parameter sets, the range of each SL-DRX parameter, or the plurality of values for each SL-DRX parameter are configured as descried above, the transmitting terminal supporting the direct communication service may transmit, to the receiving terminal, a SL-DRX configuration control message for selecting one set from among the sets, or a control message composed of SL-DRX parameters selected from the range or the plurality of values. Upon receiving the SL-DRX configuration control message from the transmitting terminal providing the broadcast and/or groupcast service, the receiving terminal may perform the SL-DRX operation using the corresponding SL-DRX parameters.

In addition, in case of a unicast service, the receiving terminal may transmit SL-DRX assistance information to the counterpart terminal (i.e., transmitting terminal) by using the control message exchanged for the PC5-RRC connection establishment procedure described in FIG. 7 or 8 or a PC5-RRC control message for SL-DRX configuration after the PC5-RRC connection establishment. Here, the SL-DRX assistance information may include information on at least one of a source identifier and/or a destination identifier of the receiving terminal, Uu DRX parameter(s) configured in the receiving terminal, and SL-DRX parameter(s) configured in the receiving terminal. In addition, the SL-DRX assistance information may further include at least one of capability information of the receiving terminal, configured grant (CG) configuration information, a sidelink service being provided to or provided by the receiving terminal (or bearer configuration information), a cast type of the sidelink service being provided to or provided by the receiving terminal, and DRX parameter(s) for the sidelink communication preferred by the receiving terminal.

Here, the CG configuration information may refer to radio resource configuration parameters of the CG scheme for radio channels of the Uu interface and/or sidelink. In addition, the terminal may request the counterpart terminal to transmit the SL-DRX assistance information. The terminal receiving the request to transmit the SL-DRX assistance information from the counterpart terminal may transmit a SL-DRX assistance information message including its UE capability information, information of a sidelink service being provided to or provided by the terminal (or bearer configuration information), a traffic identifier (or pattern) information for identifying the service, a cast type of the sidelink service being provided to or provided by the terminal, a source identifier and/or a destination identifier, CG configuration information of the Uu interface and/or sidelink configured to the terminal, and/or SL-DRX parameters and/or Uu DRX parameters configured to (or preferred by) the terminal. The terminal (e.g., the sidelink transmitting terminal or the receiving terminal) receiving the SL-DRX assistance information message from the counterpart terminal may determine SL-DRX parameters and transmit a SL-DRX configuration message to the counterpart terminal. In addition, if the terminal determining the SL-DRX parameters establishes a connection with the base station through the Uu interface, before the terminal determines the SL-DRX parameters, the terminal may deliver the SL-DRX assistance information to the base station. The base station may transmit, to the terminal, SL-DRX configuration information determined (or recommended) by the base station based on the SL-DRX assistance information received from the terminal.

Here, the SL-DRX configuration information determined (or recommended) by the base station may be a control message in a form of a list consisting of one or more SL-DRX parameter sets, or a control message indicating a range of each SL-DRX parameter or a plurality of values for each SL-DRX DRX parameter. Upon receiving the determined (or recommended) SL-DRX configuration information from the base station, the terminal may transmit finally-determined SL-DRX parameters to the counterpart terminal. If the SL-DRX parameters delivered to the counterpart terminal are different from those of the SL-DRX configuration information received from the base station, the terminal selects one set from among the SL-DRX parameter sets, or the terminal selects one from among the plurality of parameter values, the terminal may report the SL-DRX configuration information delivered to the counterpart terminal to the base station. Alternatively, the counterpart terminal receiving the SL-DRX configuration information may report the received SL-DRX configuration information to the base station (the same base station as the base station to which the terminal transmitting the SL-DRX configuration information is connected or a different base station).

The SL-DRX assistance information transmission and/or reception of the terminal supporting the direct communication function may be performed using the control message for establishing the PC5-RRC connection described above, the control message delivering UE capability information between the direct communication terminals, and/or the SL-DRX assistance information message. Therefore, according to the request of the base station or the need of the terminal for the SL-DRX operation in the broadcast or groupcast service, the terminal may use the control message in the steps S710, S713, and S717 of FIG. 7 or the S810 of FIG. 8 to deliver the SL-DRX assistance information of the terminal to the base station. In this case, the control message may be an RRC connection (re)configuration message, RRC connection release message, terminal capability information transfer message, sidelink service request message, terminal assistance information transfer message (or UE assistance information message), the control message in the step S810-0 of FIG. 8, or the like.

The above-described SL-DRX assistance information of the terminal may include SL-DRX and/or Uu DRX parameters configured to the terminal or desired by the terminal. Upon receiving the SL-DRX assistance information of the terminal from the terminal, the base station may transmit the determined (or recommended) SL-DRX configuration information to the terminal, update sidelink resource allocation for the terminal, or transmit sidelink radio resource scheduling information by using a PDCCH (or DCI) in the on-duration or active time according to the SL-DRX and/or Uu DRX operation of the terminal.

The terminal supporting the direct communication function using the SL-DRX parameters configured according to the above method may be controlled to monitor a PDCCH (or DCI) or SCI in the SL-DRX on-duration (or active time).

Regardless of the mode 1 and mode 2 schemes of SL resource allocation, the terminal may be controlled to monitor a PDCCH (or DCI) or SCI in the SL-DRX on-duration (or active time), or to transmit (or receive) a PSSCH by using a sidelink resource allocated in the CG (or SPS) scheme.

Alternatively, the above scheme may be applied limited only in the case of the mode 1 CG type 2 sidelink resource allocation scheme in which a sidelink radio resource is scheduled or activated using a PDCCH (or DCI) or SCI and/or the mode 2 sidelink resource allocation scheme. In addition, in the case of the mode 1 CG type 1 scheme, the terminal may be controlled to transmit (or receive) a PSSCH by using a sidelink resource allocated in the CG (or SPS) scheme using an RRC control message regardless of the configuration of the SL-DRX parameters.

SL-DRX Based Low Power Consumption Operation

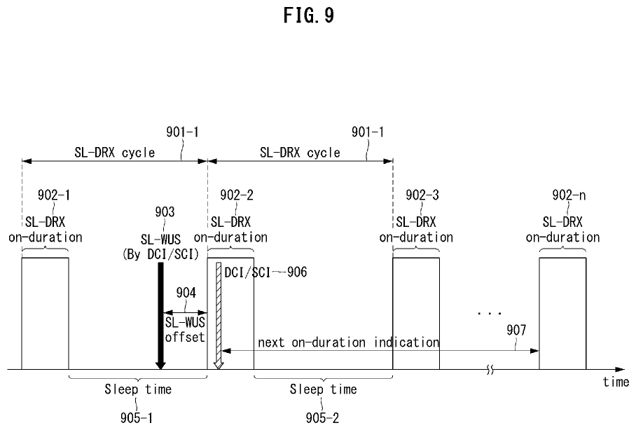

FIG. 9 is a conceptual diagram illustrating a SL-DRX-based low-power operation method of a terminal supporting a direct communication function according to an exemplary embodiment of the present disclosure.

As shown in FIG. 9, a terminal may monitor a PDCCH (or DCI) and a PSCCH (or SCI) for sidelink communication in a SL-DRX on-duration (or active time) 902 configured according to a SL-DRX cycle. When DCI or SCI 906 received in the SL-DRX on-duration (or active time) 902-2 indicates transmission or reception of a PSSCH, the terminal may transmit the PSSCH or receive the PSSCH for direct communication. Alternatively, in the SL-DRX on-duration (or active time), the terminal may additionally receive or transmit a PSSCH for direct communication in addition to the operation of transmitting or receiving the PDCCH and/or the PSCCH.

In order to support the SL-DRX operation, a time of a next SL-DRX on-duration 902-n that the terminal should monitor may be indicated by using a field parameter of the DCI or SCI. For example, when the terminal receives the DCI/SCI 906 in the SL-DRX on-duration 902-2, the corresponding DCI/SCI 906 may include information indicating the time of the next SL-DRX on-duration 902-n. The information indicating the time of the next SL-DRX on-duration may be represented by using the number of occurrences of the SL-DRX on-durations until the next SL-DRX on-duration 902-n, absolute time information (e.g., 907 in FIG. 9), an offset using the sidelink allocation resource information (or a resolution of the allocated sidelink resource), etc. Here, the absolute time information may refer to time information represented in units of a symbol, a minislot, a slot, a subframe, or a frame, or may refer to time information represented in a time unit such as a millisecond (ms) or second (sec).

In particular, the transmitting terminal and/or the base station supporting the direct communication function may transmit SCI and/or DCI even when PSSCH reception is not required for the terminal performing the SL-DRX operation in the on-duration. In this case, a specific format may be applied to the corresponding SCI and/or DCI or a specific field parameter of the corresponding SCI and/or DCI may be used to inform the receiving terminal that PSSCH reception is not required. Such the SCI and/or DCI may be used to notify the receiving terminal that PSSCH reception is not required, and may be used for other terminals supporting the direct communication function to perform sensing on the corresponding carrier or BWP, and/or the corresponding sidelink radio resource (or sidelink resource pool). In this case, the corresponding SCI and/or DCI may be configured to have a predetermined symbol pattern to improve the sensing performance. In addition, the corresponding SCI and/or DCI may be configured to include a load state of the carrier, BWP, and/or sidelink radio resource (or sidelink resource pool), an occupancy ratio of the sidelink radio resource, or the number of terminals to which the direct communication function service is being provided.

The base station and/or the terminal performing the direct communication function may transmit a control message indicating to stop the SL-DRX operation or indicating to start the SL-DRX operation. The control message indicating to stop the SL-DRX operation or start the SL-DRX operation may be transmitted by being configured as a physical layer control channel, MAC layer control message, or RRC layer control message. When the message indicating to stop (or start) the SL-DRX operation is transmitted as a physical layer control channel, the message may be transmitted as a field parameter of DCI or SCI, or may be transmitted by being configured with a specific DCI or SCI format for indicating to stop (or start) the SL-DRX operation. Here, the DCI or SCI indicating to stop (or start) the SL-DRX operation may include field parameters such as a SL-DRX operation stop (or start) indicator, a source L1 ID, a destination L1 ID, and/or cast type indication information which indicates a target of the stop or start of the SL-DRX operation, and/or the like. When the message indicating to stop (or start) the SL-DRX operation is transmitted as a MAC layer control message, the message may be configured in form of a MAC subheader and/or a MAC control element (CE). The MAC layer control message may be transmitted as a MAC subheader of a specific format for the purpose of indicating to stop (or start) the SL-DRX operation, or a MAC CE including a LCD configured for the corresponding purpose or information on the target of the stop (or start) of the SL-DRX operation. Here, the information constituting the MAC CE may include a source ID, a destination ID, a sidelink logical channel (or logical channel group) identifier, and/or cast type indication information. When the message indicating to stop (or start) the SL-DRX operation is transmitted as an RRC layer control message, the control message may include a source ID, a destination ID, a sidelink bearer identifier, and/or cast type indication information.

In addition, a wake-up signal (e.g., SL-WUS) (903 in FIG. 9) indicating DCI (or SCI) monitoring for the sidelink to the terminal performing the SL-DRX operation may be transmitted. The SL-WUS 903 may be transmitted on a PDCCH, PSCCH, DCI, SCI, or the like in a slot immediately before the SL-DRX on-duration 902-2 or at a time earlier by a SL-WUS offset 904 than the start time of the SL-DRX on-duration 902-2. The value of the SL-WUS offset 904 may be set in units of symbols, minislots, slots, subframes, or frames. Here, the base station and/or the terminal that determines the SL-DRX operation parameters may set the SL-WUS offset differently for each target terminal and transmit the SL-WUS offset to each target terminal. Here, that the SL-WUS offset is set differently for each terminal means that the SL-WUS offset may be set differently for each sidelink bearer identifier, sidelink scheduling identifier, source ID, and/or destination ID.

When the SL-WUS is transmitted in form of a PDCCH or DCI, the SL-WUS may be transmitted using a separate DCI format or a control field (e.g., DCI field parameter) within the PDCCH. That is, if the corresponding DCI field is configured for SL-WUS transmission in the PDCCH and the value of the field is set to ‘1’, it may represent SL-WUS indication (on the contrary, the value of ‘0’ may indicate the SL-WUS indication). Alternatively, transmission of a PDCCH by using a scheduling identifier (e.g., SL-RNTI, SL-SPS-RNTI, SL-RNTI, SL-SPS-RNTI, or a scheduling identifier allocated for SL-WUS transmission) uniquely assigned to the terminal may replace the SL-WUS. Alternatively, DCI including a parameter or a field for SL-WUS indication may be transmitted. In addition, a PDCCH or DCI for transmitting the SL-WUS may be transmitted as including information indicating a time of a next on-duration (e.g., 907 of FIG. 9), information on a timer indicating a time of performing a sidelink monitoring operation, and/or the like in order to control operations of the terminal according to reception of the SL-WUS.

On the other hand, when the SL-WUS is transmitted in form of a PSCCH or SCI, a field parameter may be configured in the SCI, and if a value of the corresponding field is set to ‘1’, it may represent SL-WUS indication (on the contrary, a value of ‘0’ value may represent the SL-WUS indication). Alternatively, a SCI format for SL-WUS transmission may be configured, and transmission of the SCI format may replace the SL-WUS. In addition, the SCI including the SL-WUS field parameter or the SCI to which the SCI format indicating SL-WUS transmission is applied may be transmitted as including information indicating a time of a next on-duration (e.g., 907 of FIG. 9), information on a timer indicating a time of performing a sidelink monitoring operation, and/or the like in order to control operations of the terminal according to reception of the SL-WUS.

Further, the SCI for transmitting the SL-WUS may be transmitted in association with the cast type indication information in the SCI. For example, if the cast type indication information indicates a broadcast or groupcast, the terminal receiving the SL-WUS may perform a sidelink DCI or SCI monitoring operation in the SL-DRX on-duration in which the SL-WUS indicates to perform monitoring. On the other hand, if the cast type indication information indicates a unicast, the terminal receiving the SL-WUS may be controlled to stop the SL-DRX operation and perform reception and/or transmission of a sidelink channel as well as DCI or SCI monitoring.

When the terminal performing the SL-DRX operation receives the SL-WUS at a SL-WUS reception time (or SL-WUS reception occasion) according to the above-described method, the terminal may perform a DCI (or SCI) monitoring operation in the corresponding on-duration, or may stop the SL-DRX operation and perform a transmission operation of a sidelink channel as well as the DCI or SCI monitoring. The terminal receiving the SL-WUS indicating to monitor a PDCCH, PSCCH, DCI, or SCI, etc. may perform a transmission and/or reception operation of a sidelink channel according to the SL-WUS and/or DCI/SCI 906 received after the SL-WUS even after the SL-DRX on-duration ends.

However, if the terminal performing the SL-DRX operation does not receive the SL-WUS indicating wake-up of the terminal at a SL-WUS reception time (or SL-WUS reception occasion) according to the method described above, the terminal may not perform a monitoring operation for a PDCCH, PSCCH, DCI, or SCI until the time of the next SL-DRX on-duration. That is, the terminal receiving the SL-WUS indicating to stop monitoring of a PDCCH, PSCCH, DCI, or SCI, etc. or not receiving the SL-WUS indicating monitoring of a PDCCH, PSCCH, DCI, or SCI, etc. may not perform a monitoring operation of a PDCCH, PSSCH, DCI, SCI, or the like until the next SL-WUS reception time (or SL-WUS reception occasion) indicated by the next on-duration time indication information of FIG. 9 (i.e., 907 of FIG. 9). In addition, when receiving the SL-WUS indicating to perform a monitoring operation of a PDCCH, PSCCH, DCI, SCI, etc. at the next SL-WUS reception time (or SL-WUS reception occasion), the terminal may perform a DCI (or SCI) monitoring operation in the corresponding SL-DRX on-duration or may stop the SL-DRX operation and perform a transmission operation of a sidelink channel as well as the DCI or SCI monitoring.

Further, the DCI or SCI delivering the SL-WUS may be configured by including a source L1 ID, a destination L1 ID, and/or cast type indication information, which indicates a wake-up target, as a field parameter.

The above-described SL-DRX parameters, the next SL-DRX on-duration indication information (or information on a SL-WUS periodicity or an interval between SL-WUS occasions) for SW-WUS operation, or information on a timer indicating execution time of the sidelink monitoring operation after reception of the SL-WUS may be delivered to the terminal in form of an RRC control message or system information.

SL-WUS Based Low Power Consumption Operation

On the other hand, the low power consumption operation of the terminal supporting the direct communication function may be performed only by configuring SL-WUS signaling and related parameters without configuring the above-described SL-DRX parameters.

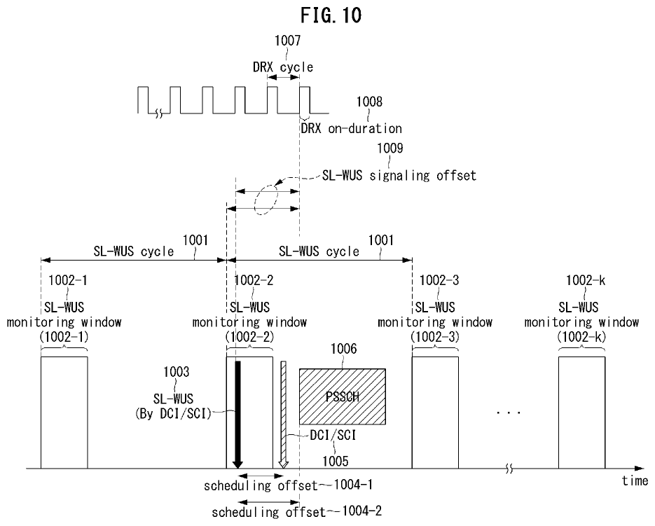

FIG. 10 is a conceptual diagram illustrating a SL-WUS signaling-based low-power operation method of a terminal supporting a direct communication function according to an exemplary embodiment of the present disclosure.

As shown in FIG. 10, configuration information of a SL-WUS periodicity 1001, a SL-WUS monitoring window 1002, DCI or SCI for transmitting a SL-WUS 1003, a scheduling offset 1004, and/or a SL-WUS signaling offset 1009 for the SL DRX operation may be delivered to the terminal in form of an RRC control message or system information. The terminal supporting the direct communication function may identify existence of the SL-WUS 1003 within the SL-WUS monitoring window 1002 configured for each SL-WUS cycle 1001 during the SL-DRX operation. The SL-WUS monitoring window 1002 may be configured with one or more symbols, minislots, slots, subframes, or radio frames.

The SL-WUS 1003 transmitted using DCI or SCI may be transmitted according to the method described above with reference to FIG. 9. A radio resource region of the DCI/SCI delivering the SL-WUS 1003 may be preconfigured. A control resource set (i.e., CORESET) or a search space for the DCI or SCI delivering the SL-WUS 1003, or a radio resource region for a PSCCH transmitting the SCI delivering the SL-WUS 1003 may be preconfigured within the SL-WUS monitoring window 1002, and the corresponding information may be delivered to the terminal together with other SL-WUS configuration information. Accordingly, the terminal may receive the SL-WUS by monitoring only the CORESET or search space preconfigured for transmission of the SL-WUS, or the preconfigured radio resource region of the PSCCH transmitting SCI delivering the SL-WUS.

The terminal receiving the SL-WUS 1003 within the SL-WUS monitoring window 1002 may stop the SL-DRX operation, and may receive a PSSCH 1006 in a resource indicated by sidelink scheduling information delivered through the DCI/SCI transmitting the SL-WUS, or transmit the PSSCH 1006 by using the corresponding resource. When the DCI/SCI 1003 for SL-WUS signaling transmits only the SL-WUS, DCI/SCI 1005 for transmitting sidelink scheduling information may be additionally transmitted. That is, after receiving the SL-WUS 1003, the terminal may receive the DCI/SCI 1005 including the sidelink scheduling information, and receive the PSSCH 1006 from a resource indicated by the corresponding scheduling information or transmit the PSSCH 1006 by using the corresponding resource. In this case, a scheduling offset 1004-1 between a time of the SL-WUS signaling 1003 and a time of the DCI/SCI 1005 including the sidelink scheduling information or a scheduling offset 1004-2 between the time of the SL-WUS signaling 1003 and a time of the PSSCH 1006 may be configured separately. The terminal receiving the SL-WUS indicating monitoring of a PDCCH, PSCCH, DCI, or SCI, etc. may perform a transmission and/or reception operation of a sidelink channel according to the SL-WUS 1003 and/or DCI/SCI 1005 received after the SL-WUS 1003 even after the SL-WUS monitoring window ends. The terminal that has completed the transmission and/or reception operation of the PSSCH 1006 according to the SL-WUS 1003 and/or the DCI/SCI 1005 after the SL-WUS 1003 may be controlled to stop a monitoring operation on sidelink channels until the next SL-WUS monitoring window.

The terminal not receiving valid SL-WUS signaling within the SL-WUS monitoring window may not perform a DCI and/or SCI reception operation for a sidelink channel until the next SL-WUS monitoring window, and may not perform a reception and/or transmission of a sidelink channel.

Information indicating the time of the radio resource region (or corresponding radio resource) in which the SL-WUS 1003 is transmitted for the low-power operation according to FIG. 10 or the time of the SL-WUS monitoring window 1002-2 may be configured to the terminal by using a SL-WUS signaling offset 1009. Here, the SL-WUS signaling offset 1009 may be set based on a Uu DRX operation parameter of a Uu interface configured for the terminal. Accordingly, the SL-WUS signaling offset 1009 may be set to a different value for each terminal. Here, that the SL-WUS signaling offset 1009 is set differently for each terminal means that the SL-WUS signaling offset 1009 may be set differently for each sidelink bearer identifier, sidelink scheduling identifier, source ID, and/or destination ID. When the SL-WUS signaling offset is set based on a start point of a Uu DRX cycle 1007 configured for each terminal or a start point of a Uu DRX on-duration 1008, one or more terminals may be aligned or controlled to receive the SL-WUS signaling within the SL-WUS monitoring window.

The DCI and/or SCI for SL-WUS signaling of FIGS. 9 and 10 described above may include a source ID, destination ID, and/or cast type indication information that indicates a SL-WUS signaling target. In addition, the parameters such as the SL-DRX cycle 901, SL-DRX on-duration 902, SL-WUS offset 904, and next on-duration time indication information 907 of FIG. 9 for the corresponding SL-WUS signaling, and the parameters such as the SL-WUS cycle 1001, SL-WUS monitoring window 1002, DCI or SCI delivering the SL-WUS 1003, scheduling offset 1004, and SL-WUS signaling offset 1009 may be configured for each terminal group, source ID, destination ID, or cast type. That is, one or more SL-WUS signaling parameter sets may be configured for the terminal supporting the direct communication function according to the terminal group, source ID, destination ID, or cast type.

In addition, the configuration information for the above-described SL-WUS signaling or some parameters of the configuration information may be configured for a unit of a base station (or cell), a RAN-based notification area (RNA), system information (SI) area (e.g., area identified by a systemInformationAreaID), or a zone for a sidelink service (e.g., area identified by a zone ID). Therefore, when the base station (or cell), RNA, SI area, zone, or the like is changed, the terminal may perform a procedure of updating the SL-WUS signaling configuration information by using a control message of the system information update, area update, or zone update/reconfiguration procedure. That is, when the base station (or cell), RNA, SI area, or zone is changed according to a movement of the terminal, the terminal may determine whether the configuration information for SL-WUS signaling or some parameters of the configuration information is changed or valid. The terminal may determine whether the configuration information of the SL-WUS cycle, SL-WUS monitoring window, DCI or SCI for transmitting the SL-WUS, scheduling offset, or SL-WUS signaling offset is changed or valid, and when the corresponding parameter is changed or invalid, the terminal may perform a procedure of changing the corresponding parameter or reconfiguring it to a valid parameter.

The terminal performing the SL-DRX operation according to the above-described SL-DRX parameter configuration and/or the SL-DRX operation method may stop the SL-DRX operation in at least one of the following cases, and may perform a monitoring operation on a downlink channel from the base station and/or a sidelink channel from another terminal (or node).
When reception of a sidelink channel and/or sidelink packet fails to reach a preset condition
Here, the preset condition may mean a case in which a timer expires and/or a counter (e.g., the number of failed receptions) reaches a preset threshold.
When a radio link problem of the sidelink and/or Uu interface is detected (or occurs)
Here, the radio link problem refers to a case in which a beam failure detection, beam failure recovery, or radio link failure (RLF) for a radio link of the sidelink and/or Uu interface occurs.
When the terminal enters a new cell or a new zone for direct communication service
When the terminal is out of a service area (out of coverage)
When the terminal fails to maintain physical layer synchronization (out of synchronization) or loses a source of a sidelink synchronization reference
Here, the source of the synchronization reference may refer to a synchronization signal of the base station, a signal such as GNSS, and/or a synchronization signal block (SSB), sidelink synchronization signal (SLSS), physical sidelink broadcast channel (PSBCH), or the like from another direct communication terminal.
When a radio quality (e.g., RSRP, RSRQ, SINR, or RSSI) of a sidelink channel does not satisfy a preset condition
Here, the radio quality of the sidelink channel may refer to a radio channel quality of the SSB, SLSS, PSBCH, PSCCH, or PSCCH of the sidelink, and/or a reference signal (RS) of the sidelink channel.
When a channel complexity (e.g., channel busy ratio (CBR)), a sidelink channel occupancy ratio (e.g., SL CR), and/or an interference signal for the allocated or selected sidelink radio resource satisfies a preset condition
When a control message indicating to stop the SL-DRX operation or release a corresponding sidelink bearer is received from the base station and/or the counterpart terminal

In the low power consumption operation of the terminal supporting the direct communication function, when the information indicating that the terminal is a terminal installed in a vehicle or a terminal connected to an external (or additional) power supply is delivered to the base station or the counterpart terminal by using a control message, the base station or counterpart terminal may deliver control (or indication) information for allowing the corresponding terminal to perform operations such as monitoring of a sidelink channel, PSSCH reception and/or transmission, etc. regardless of the above-described SL-WUS signaling. Accordingly, the terminal installed in a vehicle or the terminal connected to an external (or additional) power supply may perform the monitoring operation on sidelink channels and PSSCH reception and/or transmission operation regardless of the above-described SL-WUS signaling and//or the SL-DRX operation.

In addition, the base station or the counterpart terminal may transmit a control message (e.g., SL-DRX command) indicating to perform (or start) the above-described SL-DRX operation to the terminal receiving a sidelink service. Upon receiving the SL-DRX command, the terminal may stop a transmission/reception operation for a sidelink channel and perform (or start) the SL-DRX operation. The SL-DRX command may be transmitted as a MAC control message (i.e., MAC CE) or transmitted on a physical layer control channel (i.e., PDCCH or PSCCH). When the SL-DRX command is transmitted on a physical layer control channel, a field parameter constituting DCI or SCI, a specific format of DCI or SCI for delivery of the SL-DRX command, and/or a physical layer control channel masked with a scheduling identifier preconfigured for delivery of the SL-DRX command (e.g., SL-DRX Command-RNTI) may be applied. The SL-DRX command according to the above-described scheme may be transmitted separately for each sidelink bearer, sidelink scheduling identifier, source ID, and/or destination ID, terminal, and/or terminal group.

The starting (or restarting) time point, ending time point, or stopping time point of the above-described timer, counter, offset, period, or periodicity may be configured in units of symbols, minislots, slots, subframes, or frames.

The cell (or base station) of the present disclosure may refer to a road side unit (RSU), a radio remote head (RRH), a transmission point (TP), a transmission and reception point (TRP), or a gNB, in addition to the NodeB, the evolved NodeB, the base transceiver station (BTS), the radio base station, the radio transceiver, the access point, or the access node as the base station described in FIG. 1.

Also, the terminal of the present disclosure may refer to an Internet of Thing (IoT) device, a mounted module/device/terminal, or an on board device/terminal, in addition to the terminal, the access terminal, the mobile terminal, the station, the subscriber station, the mobile station, the mobile subscriber station, the node, or the device as the UE described in FIG. 1.

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the exemplary embodiments of the present disclosure and their advantages have been described in detail, it should be understood that various changes, substitutions and alterations may be made herein without departing from the scope of the present disclosure.

What is claimed is:

1. An operation method of a sidelink (SL) receiving terminal for low power consumption, the operation method comprising:
transmitting sidelink-discontinuous reception (SL-DRX) assistance information for configuring DRX for SL communication to a SL transmitting terminal; and
receiving configuration information of DRX parameters for the SL communication configured based on the SL-DRX assistance information from the SL transmitting terminal,
wherein the DRX parameters for the SL communication are determined by the SL transmitting terminal or a base station to which the SL transmitting terminal is connected based on the SL-DRX assistance information.

2. The operation method according to claim 1, wherein the SL communication is SL communication for a unicast service, and the SL communication is based on a mode 1 resource allocation scheme.

3. The operation method according to claim 1, wherein the SL-DRX assistance information is transmitted through a message for establishing a PC5-radio resource control (RRC) connection between the SL receiving terminal and the SL transmitting terminal or a PC5-RRC control message after the PC5-RRC connection is established.

4. The operation method according to claim 1, wherein the SL-DRX assistance information includes at least one of a source identifier and/or a destination identifier, Uu DRX parameter(s) configured in the SL receiving terminal, and SL-DRX parameter(s) configured in the SL receiving terminal.

5. The operation method according to claim 4, wherein the SL-DRX assistance information further includes at least one among capability information of the SL receiving terminal, configured grant (CG) configuration information, a SL service being provided to or provided by the SL receiving terminal, bearer configuration information, a cast type of the SL service being provided to or provided by the SL receiving terminal, and DRX parameter(s) for the SL communication preferred by the SL receiving terminal.

6. The operation method according to claim 1, wherein when the DRX parameters for the SL communication are determined by the base station, the SL transmitting terminal transfers the SL-DRX assistance information to the base station, and the base station determines the DRX parameters for the SL communication based on the SL-DRX assistance information transferred from the SL transmitting terminal.

7. The operation method according to claim 6, wherein the SL-DRX assistance information is transmitted as being included in an RRC connection (re)configuration message, an RRC connection release message, a capability information transfer message of the SL transmitting terminal, a sidelink service request message, and/or a UE assistance information message between the SL transmitting terminal and the base station.

8. The operation method according to claim 1, further comprising reporting the DRX parameters for the SL communication to a base station to which the SL receiving terminal is connected.

9. An operation method of a sidelink (SL) transmitting terminal for supporting low power consumption operations of a SL receiving terminal, the operation method comprising:
receiving sidelink-discontinuous reception (SL-DRX) assistance information for configuring DRX for SL communication from the SL receiving terminal; and
transmitting configuration information of DRX parameters for the SL communication configured based on the SL-DRX assistance information to the SL receiving terminal,
wherein the DRX parameters for the SL communication are determined by the SL transmitting terminal or a base station to which the SL transmitting terminal is connected based on the SL-DRX assistance information.

10. The operation method according to claim 9, wherein the SL communication is SL communication for a unicast service, and the SL communication is based on a mode 1 resource allocation scheme.

11. The operation method according to claim 9, wherein the SL-DRX assistance information is transmitted through a message for establishing a PC5-radio resource control (RRC) connection between the SL receiving terminal and the SL transmitting terminal or a PC5-RRC control message after the PC5-RRC connection is established.

12. The operation method according to claim 9, wherein the SL-DRX assistance information includes at least one of a source identifier and/or a destination identifier, Uu DRX parameter(s) configured in the SL receiving terminal, and SL-DRX parameter(s) configured in the SL receiving terminal.

13. The operation method according to claim 12, wherein the SL-DRX assistance information further includes at least one among capability information of the SL receiving terminal, configured grant (CG) configuration information, a SL service being provided to or provided by the SL receiving terminal, bearer configuration information, a cast type of the SL service being provided to or provided by the SL receiving terminal, and DRX parameter(s) for the SL communication preferred by the SL receiving terminal.

14. The operation method according to claim 9, wherein when the DRX parameters for the SL communication are determined by the base station, the SL transmitting terminal transfers the SL-DRX assistance information to the base station, and the base station determines the DRX parameters for the SL communication based on the SL-DRX assistance information transferred from the SL transmitting terminal.

15. The operation method according to claim 14, wherein the SL-DRX assistance information is transmitted as being included in an RRC connection (re)configuration message, an RRC connection release message, a capability information transfer message of the SL transmitting terminal, a sidelink service request message, and/or a UE assistance information message between the SL transmitting terminal and the base station.

16. An operation method of a base station for supporting low power consumption operations of a sidelink (SL) receiving terminal, the operation method comprising:
receiving sidelink-discontinuous reception (SL-DRX) assistance information for configuring DRX for SL communication from the SL receiving terminal through a SL transmitting terminal for the SL receiving terminal; and
transmitting configuration information of DRX parameters for the SL communication configured based on the SL-DRX assistance information to the SL receiving terminal through the SL transmitting terminal,
wherein the DRX parameters for the SL communication are determined by the base station based on the SL-DRX assistance information.

17. The operation method according to claim 16, wherein the SL communication is SL communication for a unicast service, and the SL communication is based on a mode 1 resource allocation scheme.

18. The operation method according to claim 16, wherein the SL-DRX assistance information includes at least one of a source identifier and/or a destination identifier, Uu DRX parameter(s) configured in the SL receiving terminal, and SL-DRX parameter(s) configured in the SL receiving terminal.

19. The operation method according to claim 18, wherein the SL-DRX assistance information further includes at least one among capability information of the SL receiving terminal, configured grant (CG) configuration information, a SL service being provided to or provided by the SL receiving terminal, bearer configuration information, a cast type of the SL service being provided to or provided by the SL receiving terminal, and DRX parameter(s) for the SL communication preferred by the SL receiving terminal.

20. The operation method according to claim 16, wherein the SL-DRX assistance information is received as being included in an RRC connection (re)configuration message, an RRC connection release message, a capability information transfer message of the SL transmitting terminal, a sidelink service request message, and/or a UE assistance information message between the SL transmitting terminal and the base station.
